(19) United States
(12) Patent Application Publication
(10) Pub. No.: US 2016/0021181 A1
(43) Pub. Date: Jan. 21, 2016

(54) DATA FUSION AND EXCHANGE HUB - ARCHITECTURE, SYSTEM AND METHOD

(71) Applicants: George Ianakiev, Chevy Chase, MD (US); Hristo Trenkov, Rockville, MD (US)

(72) Inventors: George Ianakiev, Chevy Chase, MD (US); Hristo Trenkov, Rockville, MD (US)

(21) Appl. No.: 14/335,933

(22) Filed: Jul. 20, 2014

(51) Int. Cl. H04L 29/08; G06Q 20/08; H04L 29/06

(52) U.S. Cl. CPC H04L 67/1078; H04L 63/08; G06Q 20/085; H04L 67/1095

(57) ABSTRACT

A computerized method for facilitate and orchestrate the exchange and integration of data assets and data consumers, with or without computer appliances, automated framework comprised of technical devices for enabling integration of one or more of data assets including data streamer, structured data repository, unstructured data repository, 3rd party application, ontology, sensor, service provider, text, image, video, voice, and data consumers including human user, web portal, email, repository of data, reporting warehouse, 3rd party application, workflow, analytics process, model, ontology index, problem solver, decision system, mobile device, sensor, wearable computer. The automated framework can be one of asynchronous messaging-based, asynchronous near real-time, synchronous real-time; computer memory is used for storing applications for distribution to data consumers. The framework provides encryption, authentication, rights and roles controlling data assets, or data consumers. A user can interact with the framework to perform monitoring, management or analysis functions.

### CROSS REFERENCE TO RELATED PROVISIONAL APPLICATION

This application claims the benefit of U.S. Provisional Patent Application No. 61/857,658 filed on Jul. 23, 2013, the disclosure of which is hereby incorporated herein by reference in its entirety.

### COPYRIGHT NOTICE

Portions of the disclosure of this document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to cross-functional, cross-industry logic methods and technology-enabled infrastructure to facilitate the orchestration of fusion, exchange and integration of data. More particularly, the present invention provides an automated framework and technical devices for intelligent integration of two or more data sources or assets, data consumers, repositories and/or services together to automate, manage, synchronize, protect and/or monitor data fusion and exchange in real-time.

### BACKGROUND OF THE INVENTION

In 2010, Google's Eric Schmidt said “I don't believe society understands what happens when everything is available, knowable and recorded by everyone all the time.” He was referring to the fact that in the digital world, data are everywhere. We create them constantly, often without our knowledge or permission, and with the bytes we leave behind, we leak information about our actions, whereabouts, characteristics, and preferences.

This revolution in sensemaking—in deriving value from data—is having a profound and disruptive effect on all aspects of business from competitive advantage to advantage in an intelligent adversary situation. Simply put, with so much data available to the organizations, in both public social networks and internally generated, the ability to gain a competitive edge has never been greater and more necessary.

As usable data expands exponentially, the cost of reconfiguring systems to handle that data will increase exponentially. The rising cost of data management will make it harder to compete in a global economy with fewer capital investments. Inversely to stay competitive, larger capital investments into data system infrastructure will be needed. This rising cost of acquiring more and more useable data impedes business growth and prevents smaller enterprises from implementing such data systems^{[1]}.

If larger amounts of data can be harnessed and used in a more cost-efficient manner, then a business or organization will have a leg up compared to its competitors. More sophisticated and streamlined programs will be needed to manage this data.

Despite many organizations having already developed capabilities to derive quality from the vast quantity of available data, the next big data revolution has yet to happen in full strength thanks in large part to mobile devices. If you think of mobile devices as sensors, our phones, and tablets know more about us than any human being. Increasing integration of hardware and software (in the form of apps) systems in mobile devices will generate increasing amounts of novel data. To deal with this large influx and very valuable data, innovative systems and approach are needed to integrate, catalog, and make useable the disparate data.

This presents organizations with the “Big Data Dilemma”—where the more information is harvested and available to the Organizations, the harder it is to derive actionable and purposeful value within reasonable time, cost, and risk. In 2007, 85% of all data is in an unstructured format^{[2]}, which is to say that it has not been cataloged and made readily available for businesses and organizations to utilize easily. This number is growing as the capacity of conventional data collection surpasses the capacity for organizing that data. To make this wealth of data more usable, new technologies and methods are going to be required to describe the data ontologically. New software and hardware implementations will allow for the integration and subsequent retrieval of data. While acquiring data across different media, systems will need to be able to integrate data structured and stored in discrepant and isolated systems. Big Data has become so voluminous that it is no longer feasible to manipulate and move it all around. The data will be organized ontologically in ways to facilitate management of these data systems. These organizations will allow relevant data to be identified and retrieved easily, allowing data to be manipulated and analyzed. This will streamline the process by reducing operation time and cost, which are major sources of expenditures for organizations^{[3]}.

Development of such systems to organize data is a highly repeatable process, but a standard toolset does not exist. The absence of such a system causes businesses and organizations to reinvent how data should be integrated in place of focusing on core market activities^{[3]}. Reproducing data systems and constant adaptation of the development of data systems, will allow businesses or organizations to adopt higher quality and lower risk data systems at a lower price.

Data integration risks are often significant due to potential loss or unauthorized access of proprietary data. To ensure that such data will not be compromised, many organizations are in need of physical separation between themselves and the sources of the data. This will make it easier for companies to extract data while complying with legal regulations (for example), which will reduce cost^{[3]}.

The present invention solves the above-identified problems via various novel approaches to architect data and logic orchestration fusion platform based on managed or non-managed technical algorithms, software programs and hardware appliances.
1. http://www.wallstreetandtech.com/data-management/technology-economics-the-cost-of-data/231500503
2. http://www.forbes.com/2007/04/04/teradata-solution-software-biz-logistics-cx_rm_{—}0405data.html
3. http://www.forbes.com/2010/10/08/legal-security-requirements-technology-data-maintenance.html

### SUMMARY OF THE INVENTION

The system described in the present invention is a Data Fusion and Exchange Hub to facilitate the acquisition and management of data to derive further value by organizations and/or individuals to support operations and guide actions.

Data integration, reporting and analysis involves synchronizing huge quantities of variable, heterogeneous data resulting from wide range of internal systems, external systems and social media (some in structured and some in unstructured format), each with its own data model and unique demands for storage and extraction. Data integration and reporting becomes major effort requiring extensive resources. And when implemented, it is often with reduced value of the information due to delays and challenges to adapt to future needs—leading to questionable analysis and basis for decisions. The present invention serves as this flexible and adaptive data integration layer and enables data collaboration without the constraints of the traditional integration methods.

The present invention takes data, regardless of the source, and builds a very flexible data integration layer. It enables the connection of different sources of data incrementally as needed. An Organization can create a data fusion and exchange hub between several data sources without the need for complex integrations or transformation. At a later time, another database, streaming data source or even a spreadsheet can be added without having to build an entirely new data model. Non-technical business users can easily consume all this data into personalized reporting, dashboards, visualizations, and models to bring information back into everyday tools such as Excel.

The present invention takes data, regardless of the source, and continues to extend the data model and integrate data in, even if the Organization doesn't anticipate a particular kind of information up front. In some embodiments, the underlying ontology-based data model provides added flexibility to present data than the rational ways.

### BRIEF DESCRIPTION OF THE DRAWINGS

For a fuller understanding of the invention, reference is made to the following description taken in connection with the accompanying drawings in which:

FIG. 1 describes the overall architectural diagram of a representative embodiment of the present invention.

FIG. 2 describes the Call and Response (Asynchronous) architecture of a representative embodiment of the present invention.

FIG. 3 describes the Real-Time (Synchronous) architecture of a representative embodiment of the present invention.

FIG. 4 describes a representative architecture of the Data Integration Layer Engine.

FIG. 5 describes the features of the Graphical User Interface (GUI) of one representative embodiment of the Data Fusion and Exchange Hub.

FIG. 6 describes the Business Intelligence comprised of five layers: presentation, analytics, logic, data and integration, and 3rd party application layers.

FIG. 7 describes Call and Response architecture in a structured data embodiment.

FIG. 8 describes Call and Response Data Model in a structured data embodiment;

FIG. 9 describes Pentaho Extract, Transform, Load (ETL) uses input to match unique identifiers against FPDS reference data. Step 6 of the Case Study: Federal Acquisitions.

FIG. 10 describes Pentaho Analytics generates formatted data “Response” report with visualizations; report is stored into the Output folder. Step 7 of the Case Study: Federal Acquisitions.

FIG. 11 describes an example 1 for Filling in Excel Template. Case Study: Federal Acquisitions.

FIG. 12 describes example 1 of the received spreadsheet. Case Study: Federal Acquisitions.

FIG. 13 describes an example 2 for Filling in Excel Template. Case Study: Federal Acquisitions.

FIG. 14 describes example 2 of the received spreadsheet. Case Study: Federal Acquisitions.

FIG. 15 describes the concept of all hash-tags used—parse the JSON returned by the Twitter service, extract the first 5 hash-tags from the message, split this up into 5 rows and count the tags. Use Case: Real-Time Streaming Data Aggregation.

FIG. 16 describes the concept of counting the number of hash-tags used in a one-minute time-window—the counting uses a “Group by” step. Use Case: Real-Time Streaming Data Aggregation.

FIG. 17 describes the concept of putting the output in a browser window, continuously update every minute—done with a “Text File Output” step. Use Case: Real-Time Streaming Data Aggregation.

FIG. 18 describes the Logic Fusion representing the contradiction matrix, which provides a systematic access to most relevant subset of inventive principals depending on the type of a contradiction.

### USE CASES

This section describes, for illustrative purposes, applications of the present invention:

### Use Case: Data Fusion—Intelligence Community.

Create a matrix of known threats and monitor data and surveillance video feeds for pattern recognition match.

### Use Case: Logic Fusion—Business TRIZ Problem Solver.

Create a pattern driven master hub allowing for constraint business problem resolution informed by internal and external to the organization data.

### Use Case: Business Management (Variation of the Business TRIZ Problem Solver).

Manage analysis and decisions of business patterns defined in a public hub containing domain specific solutions, informed by external to the organization public data. Private instances of the Public Hub are then created for each specific Organizational instance, allowing private to the Organization data to be added into the analysis and decision processes.

### Case Study: Knowledge Fusion—Self-Learning Knowledge Repository.

Create self-learning ontology based knowledge repository of what an employee knows and what the organization knowledge base knows.

### Case Study: Financial Industry (Stock Trading).

Create a matrix of known factors influencing stock fluctuation (financial, political, environment-related events). Offer a service where individual traders and brokerage firms can get access to the filtered data using a subscription model.

### Case Study: Internal Revenue Service.

Create a messaging service-to-service state health exchanges income verification (using SSNs) as part of the healthcare reform.

### Case Study: Appliance Servicing Intelligence Community.

Face recognition from image (including images stored in social networks), video feeds while sending/receiving data from portable devices (tablets, Google glass, blackberries).

### Case Study: Retail Industry.

Collect and sort based on pre-defined semantic model that categorizes multi-vendor pricing to allow context sensitive price check on the best price offered by multiple vendors—target consumers, Amazon.

### Use Case: Investigation, PDs, and Criminology.

Create a matrix of evidence types mapped to geolocation, criminology, prison systems databases. Offer as either self-hosted or subscription based service.

Use Case: Legal e-Discovery.

Create platform that can quickly scan information technology (IT) infrastructure, including potential custodial and non-custodial data sources. Once information is retrieved, it is classified using a pre-defined ontology model based on the type of e-Discovery like: patent litigations, mergers and acquisitions, securities and financial services, criminal defense, etc.

Use Care: Ontology-Based Search Engine.

Create Federated ontology-based search engine collective to answer business and science domain questions.

### Processing Architecture

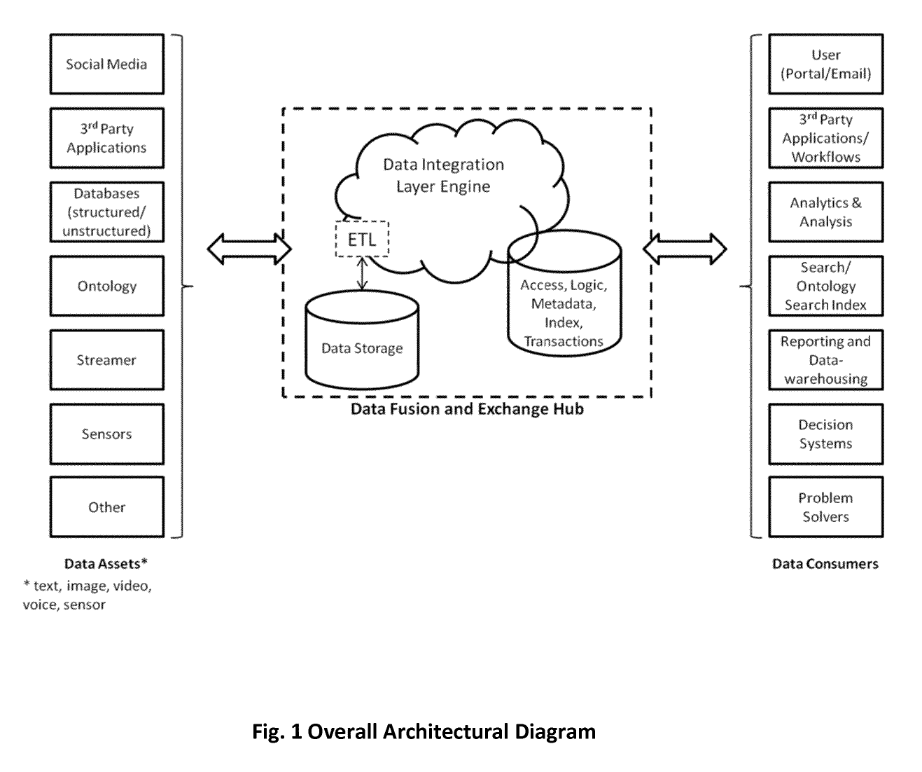

FIG. 1 describes the overall architectural diagram of a representative embodiment of the present invention. Data assets include social media, 3^{rd} party applications, structured or unstructured databases, ontologies, streamer devices, sensors, or any other meaningful for the Organization data feed or element. Data assets can be in any purposeful format, such as text, image, video, voice, or sensor output data. The Data Fusion and Exchange Hub (the present invention) acts as an adaptive and flexible data integration layer engine integrating all data assets with each other or with Data Consumers for presentation, analysis, reporting, modeling and action purposes. Data Consumers can be any process, logic, actor or agent that requires or can gain incremental value from the Data Asset(s).

The present invention has two distinct processing architectures: (1) Call and Response (or asynchronous), and (2) Real-time (or synchronous). Note that in practice, the present invention can combine the two processing architectures into a hybrid model where the two architectures can operate in parallel servicing the specific requirements of the individual data assets and/or data consumers.

### Call and Response (Asynchronous) Processing Architecture

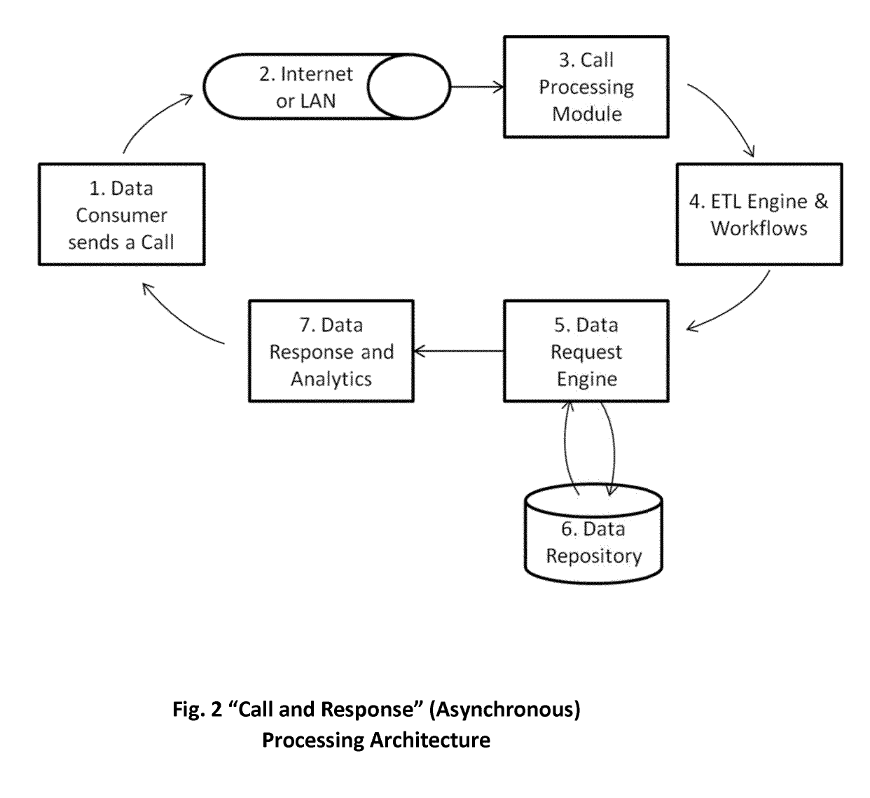

FIG. 2 describes the Call and Response (Asynchronous) architecture of a representative embodiment of the present invention.

At a high level, the processing steps are explained below:

Step 1: Data Consumer sends a data call or request for information.

Step 2: The present invention works with any Wide Area Network (WAN) or Local Area Network (LAN) communication media.

Step 3: Call Processing Module analyzes the data call and associates processing instructions.

Step 4: Extract, Transform and Load (ETL) Engine & Workflow processing step grabs the input from the Call Processing Module and prepares the data request and any required workflow functions. ETL can include transformation or information extraction logic.

Step 5: The Data Request Engine executes the data request against the reference data.

Step 6: The Data Repository (or source) returns the data set as per the data request.

Step 7: The Data Response and Analytics processing step personalizes and sends back to the Data Consumer a personalized Data Response.

### Real-Time (Synchronous) Processing Architecture

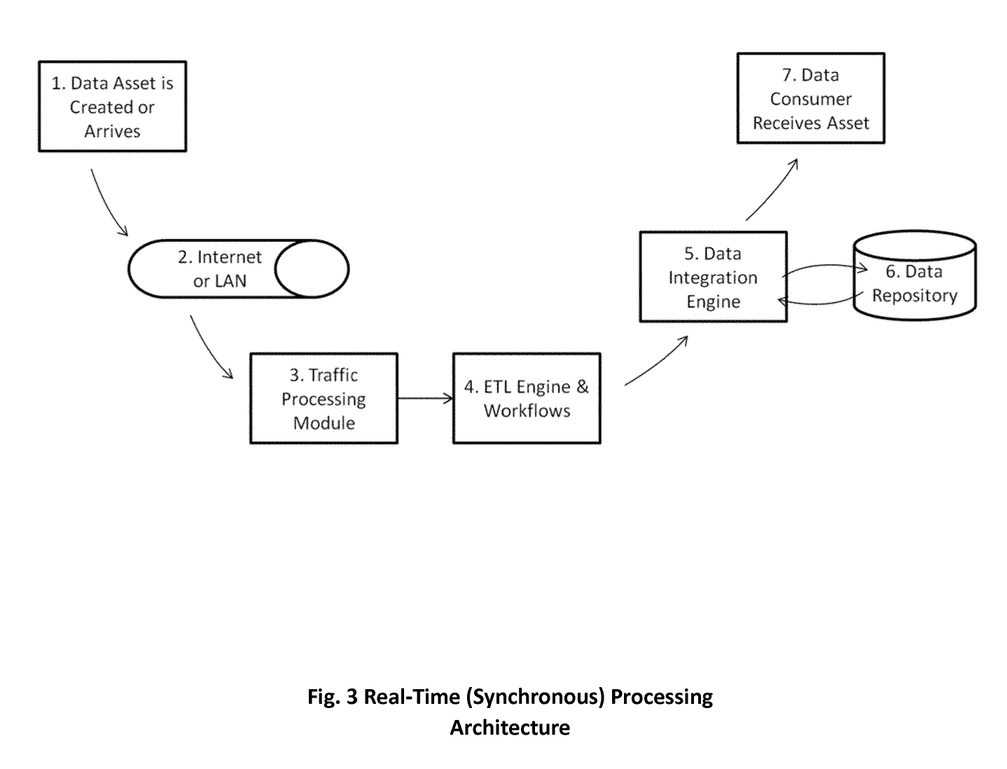

FIG. 3 describes the Real-Time (Synchronous) architecture of a representative embodiment of the present invention. At a high level, the processing steps are explained below:

At a high level, the processing steps are explained below:

Step 1: Data Asset is created, found or arrived (streamed) in the data interface.

Step 2: The present invention works with any Wide Area Network (WAN) or Local Area Network (LAN) communication media.

Step 3: Traffic Processing Module analyzes the data asset and associates processing instructions.

Step 4: Extract, Transform and Load (ETL) Engine & Workflow processing step grabs the input from the Call Processing Module and prepares the data instructions and any required workflow functions. ETL can include transformation or information extraction logic.

Step 5: The Data Integration Engine executes the data instructions and integrates it into the data repository (e.g. relational, ontology-based, etc).

Step 6: The Data Repository integrates the data asset, tags it, updates any metadata and search indexes (if applicable).

Step 7: The Data Consumer receives a “personalized” data asset. Further processing, analysis or visualization may occur as well.

### CONOPS (Concept of Operations)

This section describes possible CONOPS deployments for embodiments of the present invention.

### Public and Private Deployments

In one embodiment, the present invention can be deployed as a Public Data Fusion and Exchange Hub, where public Data Assets are integrated for use in a multi-tenant (e.g. multiple Organizations), multi-user environment. Another embodiment is also possible, where the Public Hub is replicated (or simply not made available to other Organizations) into a Private instance, specifically tailored to the needs of the Organization. This allows proprietary, Organizational specific Data Assets and Data Consumers to be integrated into the Hub.

### Appliance-Based Deployment

In one embodiment, the present invention can be deployed in an appliance-based architecture where the Data Fusion and Exchange Hub is a Master Appliance and the Data Assets are deployed as Slave Appliance(s). Slave Appliances collect data from disparate sources, and their products are relayed to the Master Appliance, which coordinates the data mining and analysis operations. The collective of appliances is managed through the Master Appliance.

### Technical Architecture

This section describes one representative embodiment of the architectural components of the Data Fusion and Exchange Hub.

### Technical Backbone and Infrastructure

The Data Fusion and Exchange Hub can be installed on either physical or virtual hardware capable of running Linux operating system (as a representative example).

Architecture: x86, x86-64, IBM Power, IBM System Z
Storage support: FC, FCoE, iSCSI, NAS, SATA, SAS, SCSI
Network support: 10M/100M/1G/10G Ethernet, Infiniband

Technical Limits

| Architecture | CPU | Memory |
|---|---|---|
| x86 | 32 | 16 GB |
| x86_64 | 128/4096 | 2 TB/64 TB |
| Power | 128 | 2 TB |
| System z | 64 | 3 TB |

File Systems (max FS size)

| | |
|---|---|
| ext3 | 16 TB |
| ext4 | 16 TB |
| XFS | 100 TB |
| GFS2 | 100 TB |

### Processing Layers (HW. OS, Data Storage, Metadata, Application, Web)

The Data Fusion and Exchange Hub consists of the following processing layers:
Hardware—physical or virtual hardware.
Operating System (OS)—collection of software that manages computer hardware resources and provides common services for computer programs.
Database—stores appliance registration and configuration management-related data, as well as application specific data (e.g. SQL, non-SQL, Ontology).
Channel Repository—delivers powerful data preparation capabilities including extract, transform and load (ETL). An intuitive and rich graphical design environment minimizes complexity and time invested in specialized scripts to prepare data. Features include: Profiling (data profiling and data quality) and Visualization (integrated semantic dimensional modeling and visualization enables iterative agile data integration and business analysis).
Business Logic—core “business logic” and entry point for the collection of supplied data through the use of agent software running on the present invention.
Application(s)—collection and processing point for data collected from appliances; in some embodiments it can include content management system (CMS) capability.

Web Interface—data asset and data consumer registration, group, user, and channel management interface. It contains also Business Analytics capabilities for information-driven decisions. Features include: Reporting (from self-service interactive reporting, to high-volume, highly formatted enterprise reporting. Output formats include: PDF, Excel, HTML, CSV, and RTF); Interactive Dashboards (delivers key performance indicators to provide business users with the critical information they need to understand and improve performance), and Mobile (provides business user on the go a true mobile experience with complete data discovery, interactive analysis, and visualization on the iPad or mobile device).

Management Tools—database and file system synchronization tools, package importing tools, channel management, errata management, user management, system and grouping tools.

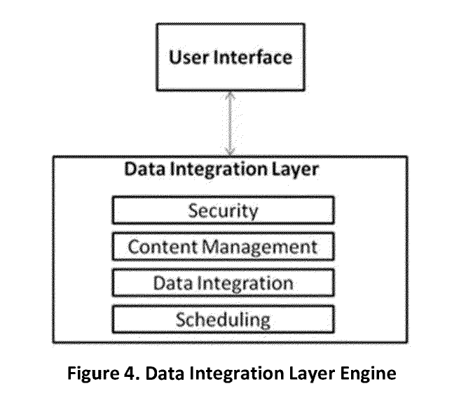

A representative architecture of the Data Integration Layer Engine is shown in FIG. 4.
Execution. Executes En jobs and transformations.
User Interface. Interface to manage ETL jobs and transformations, as well as licenses management, monitoring and controlling activity on data assets and analyzing performance trends of registered jobs and transformations.
Security. Management of users and roles (default security) or integration of security to existing security provider (e.g. LDAP or Active Directory).
Content Management. Centralized repository for managing En jobs and transformations, full revision history on transactions, content, sharing/locking, processing rules, and metadata.
Scheduling. Service for schedule and monitor activities on data integration layer engine.

### Communications

In one embodiment of the “Call and Response” (Asynchronous) Processing Architecture, the communication between the Data Consumers and the Data Fusion and Exchange Hub is based on “call” templates. These templates provide a method for validation of the validity of the “call” and significantly reduce the errors of the Request Processing Module.

Communications of the Real-time (Synchronous) Architecture are pre-negotiated and tested to eliminate errors during operational use of the present invention.

### Monitoring and Error Handling

Monitoring.

Monitoring of the Data Fusion and Exchange Hub allows administrators to keep close watch on system resources, databases, services, and applications. Monitoring provides both real-time and historical state change information of the present invention itself, as well as data assets and data consumers registered with the Data Fusion and Exchange Hub. There are two components to the monitoring system—monitoring daemon and monitoring scout. The monitoring daemon performs backend functions, such as storing monitoring data and acting on it; the monitoring scout runs on the present invention and collects monitoring data.

Monitoring allows advanced notifications to system administrators that warn of performance degradation before it becomes critical, as well as metrics data necessary to conduct capacity planning. It also allows establishing notification methods and monitoring scout thresholds, as well as reviewing status of monitoring scouts, and generating reports displaying historical data for a data asset feed or service.

Error Handling.

Error handling collects application and web server access and error logs that occur on the Data Fusion and Exchange Hub. Monitoring scouts collect errors on the registered Data Assets and Data Consumers.

### Users and Groups Management

User and User Group Management.

Ability to create, activate, inactivate, and maintain users, user roles, user attributes (e.g. name, last sign), as well as groups of users. 3^{rd} party application access in this context is also considered user access. In one embodiment, responsibilities and access is designated to users through the assignment of roles and can include:
User—standard role associated with any newly created user.
Configuration Administrator—this role enables the user to manage the configuration of the Data Fusion and Exchange Hub.
Monitoring Administrator—this role allows for the scheduling of test probes and oversight of other Monitoring infrastructure.
Administrator—this role can perform any function available, altering the privileges of all other accounts, configuring 3^{rd} party application access, configuring Data Assets and Data Consumers, as well as conduct any of the tasks available to the other roles.
System Group Administrator—this role is one step below Administrator in that it has complete authority over the systems and system groups to which it is granted access.

### Security

Communications. All communications between the Data Consumers and the Data Fusion and Exchange Hub are capable of using encrypted communication protocols.
Data. Data stored at the Data Fusion and Exchange Hub at still can be encrypted.
Access. Security access authentication can be done at the Data Fusion and Exchange Hub or based on a security provider (such as LDAP or Active Directory).

### Graphical User Interface (GUI)

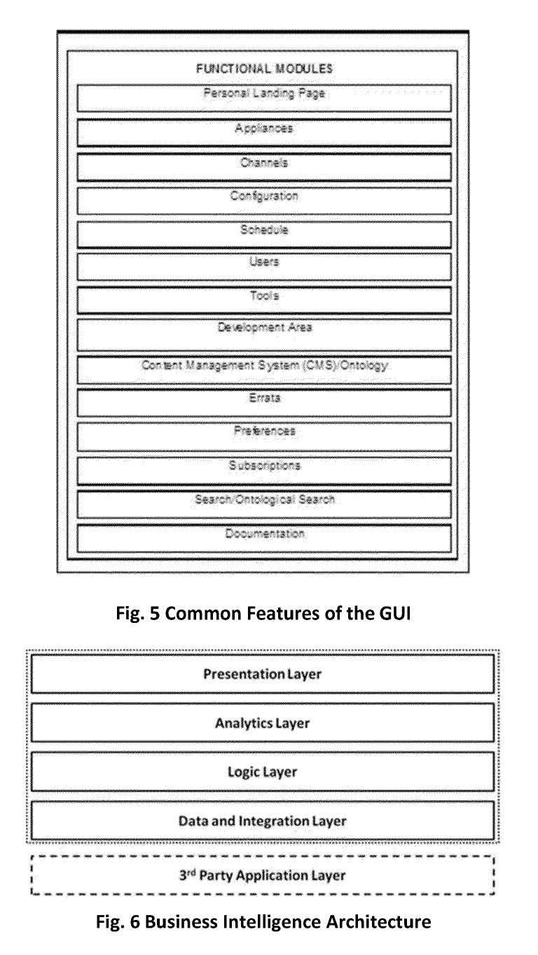

FIG. 5 below provides a snapshot of the features of the GM of one representative embodiment of the Data Fusion and Exchange Hub.

### Content Management System/Ontology

A Content Management System (CMS) is a computer program that allows publishing, editing and modifying content as well as maintenance from a central interface. Such systems of content management provide procedures to manage workflow in a collaborative environment. In general, CMS stores and manages Metadata about data and can be in a relational format (e.g. SQL database) or non-relational format (e.g. Ontological data repository). CMS capability can be deployed into the present invention, when needed.

In computer science and information science, Ontology formally represents knowledge as a set of concepts within a domain, and the relationships between pairs of concepts. It can be used to model a domain and support reasoning about concepts.

In theory, Ontology is a “formal, explicit specification of a shared conceptualization”. The Ontology provides a shared vocabulary, which can be used to model a knowledge domain, that is, the type of objects and/or concepts that exist, and their properties and relations.

Ontologies are the structural frameworks for organizing information and are used in artificial intelligence, the Semantic Web, systems engineering, software engineering, biomedical informatics, library science, enterprise bookmarking, and information architecture as a form of knowledge representation about the world or some part of it. The creation of domain ontologies is also fundamental to the definition and use of an enterprise architecture framework.

Ontologies share many structural similarities, regardless of the language in which they are expressed. Ontologies describe individuals (instances), classes (concepts), attributes, and relations. Common components of ontologies include:
Individuals: instances or objects (the basic or “ground level” objects).
Classes: sets, collections, concepts, classes in programming, types of objects, or kinds of things.
Attributes: aspects, properties, features, characteristics, or parameters that objects (and classes) can have.
Relations: ways in which classes and individuals can be related to one another.
Function terms: complex structures formed from certain relations that can be used in place of an individual term in a statement.
Restrictions: formally stated descriptions of what must be true in order for some assertion to be accepted as input.
Rules: statements in the form of an if-then (antecedent-consequent) sentence that describe the logical inferences that can be drawn from an assertion in a particular form.
Axioms: assertions (including rules) in a logical form that together comprise the overall theory that the ontology describes in its domain of application. This definition differs from that of “axioms” in generative grammar and formal logic. In those disciplines, axioms include only statements asserted as a priori knowledge. As used here, “axioms” also include the theory derived from axiomatic statements.
Events: the changing of attributes or relations.
Reasoning: helps produce software that allows computers to reason completely, or nearly completely, automatically.

In some embodiments, one can build ontology language upon Resource Description Framework (RDF). The RDF data model capture statements about resources in the form of subject-predicate-object expressions (or triples). RDF-based data model is more naturally suited to certain kinds of knowledge representation than the relational model and other ontological models.

### Search/Ontology Search

Keyword Search. Uses keywords and Boolean logic to retrieve information from a data repository.
SQL Search. Structure Query Language (SQL) as a mean to retrieve data from a structured database.
Ontology Search. It is common that the keyword-based search misses highly relevant data and returns a lot of irrelevant data, since the keyword-based search is ignorant of the type of resources that have been searched and the semantic relationships between the resources and keywords. In order to effectively retrieve the most relevant top-k resources in searching in the Semantic Web, some approaches include ranking models using the ontology, which presents the meaning of resources and the relationships among them. This ensures effective and accurate data retrieval from the ontology data repository.

### Business Intelligence

Business Intelligence (BI). The Business Intelligence layer is componentized, modular and scalable. The BI architecture is organized in five levels, as shown in FIG. 6.
Presentation Layer. Includes browser, portal, office, web service, email and other traditional or custom ways to present or display information.
Analytics Layer. Includes four sub layers:
   Reporting: Tactical, Operational, Strategic level reporting, which can be scheduled or ad-hoc.
   Analysis: Includes ability for Data Mining, OLAP, Drill & Explore, Model,
   Knowledge. Domain specific sub analysis layer is also available.
   Dashboards: Includes metrics, KPIs, Alerts, and Strategy and Action.
   Process Management: Includes integration, definition, execution, and discovery of processes, steps or sub-steps.
Logic Layer. Includes Security, Administration, Business Logic, and Content Management.
Data and Integration Layer. Includes ETL, Metadata, knowledge/ontology, EII]
3rd Party Application Layer. Includes ERP/CRM, Legacy Data, OLAP, Local Data, and Other Applications.

### Supported Device Types for User Interface

Sample list of supported devices include (but are not limited to)
Apple iPad, iPod, iPhone
Android Tablet, Mini-Tablet or Smartphone
Windows Mobile® Tablet or Smartphone

### Case Studies

This section contains illustrative examples of embodiments of the present invention.

### Use Case: Database “Call and Response” Services

Case Study: Federal Acquisitions.

This use case is an illustration of the “Call and Response” Asynchronous Processing Chain Architecture. Database “Call and Response” services refer to functionality that enables individual Data Consumers or “users” to get information within a well-defined database—e.g. USASpending.gov and FPDS (Federal Procurement Data Systems) data—in a simple, stylish, no frill way without use of a visual interface (e.g., a web portal).

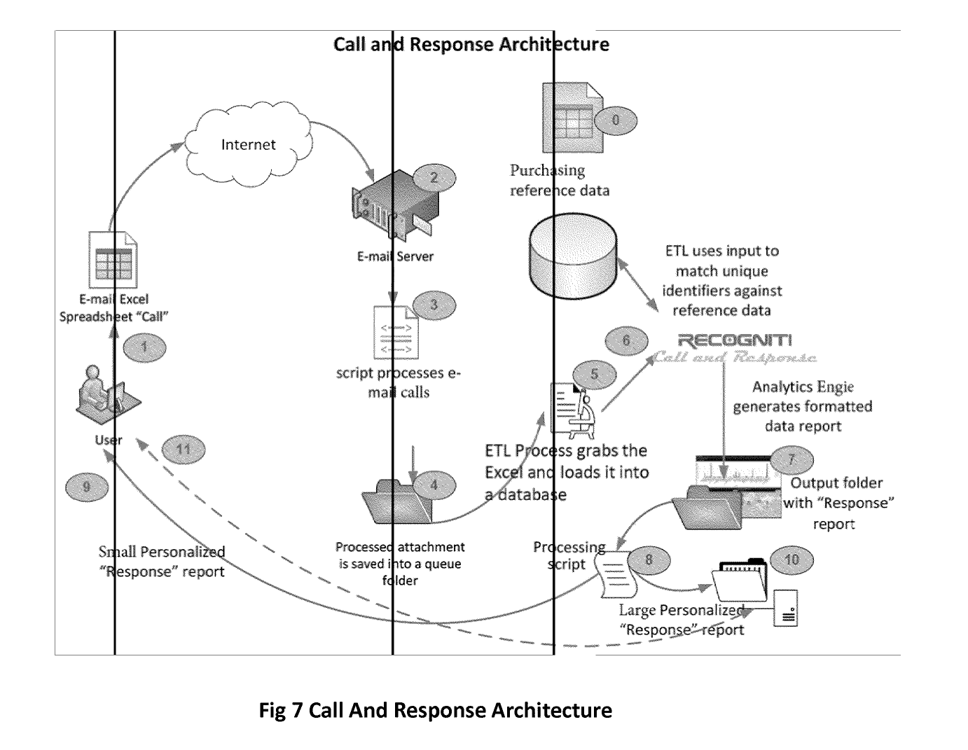

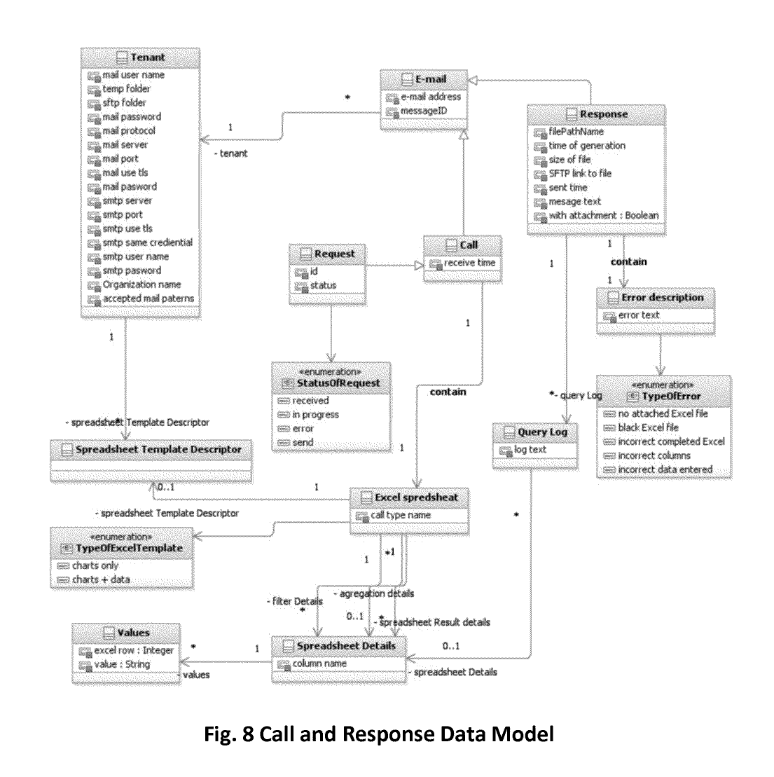

FIG. 7 describes the Call and Response Architecture for embodiment of the present invention's Call and Response Engine is a messaging system for asynchronous processing of “call” messages containing specific query, processing this query, and packaging the results from the call query into a “response” in raw data or in a form for analysis or intelligence modeling. The data model for this embodiment is depicted in FIG. 8.

Four discrete steps comprise the “Call and Response” Data Fusion and Exchange Hub:

1. A user generated Excel spreadsheet that contains unique identifiers is emailed as an attachment to a specific e-mail address.

2. Once received, a computer code (the Request Processing Module) will strip the unique identifiers (the ETL Engine & Workflows) and load them into a relational database (the Data Call Engine).

3. A program will map the unique identifiers against a relational database that contains reference data (copy of FPDS database), then create a formatted data report with visualizations, e.g. data, charts, maps (the Data Response Engine).

4. The program then emails back this personalized report to the user.

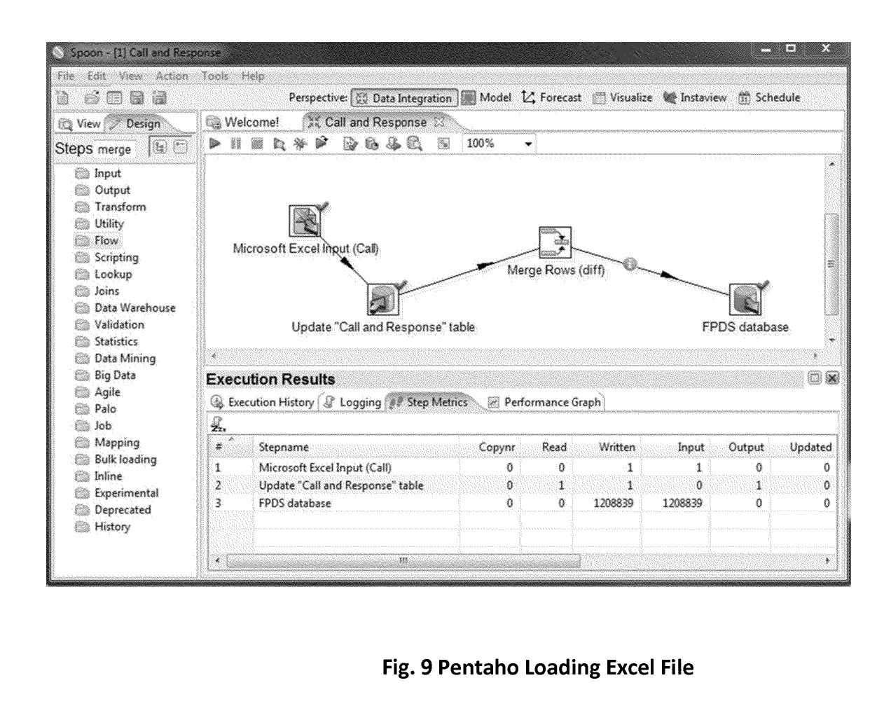

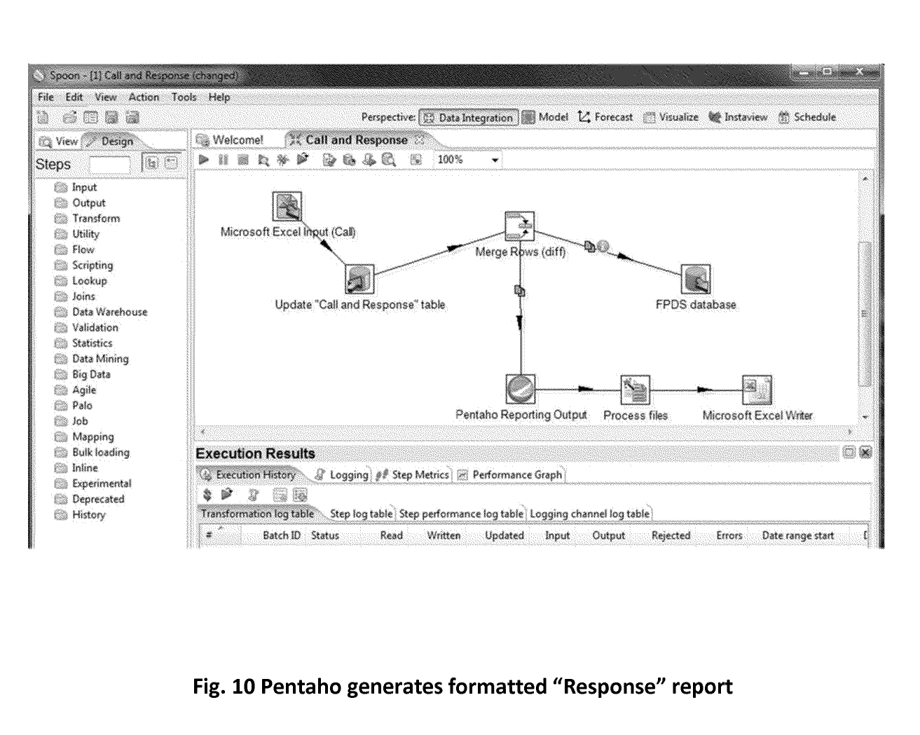

Below are the high-level processing steps based on Pentaho solution stack:
Step 0: Initial Load—FPDS reference data feed is loaded and refreshed on a scheduled basis; this process is automated and is monitored via real-time warnings and alerts
Step 1: User prepares and emails spreadsheet template with the “Call”
Step 2: E-mail Server receives the email containing the “Call” spreadsheet
Step 3: Script processes the Excel e-mail attachment, as well as retrieves details like sender e-mail address, date received
Step 4: Processed attachment is saved into a queue folder and awaiting further processing
Step 5: Pentaho ETL processes grabs Excel input from folder and loads it into the transaction repository database
Step 6: Pentaho ETL uses input to match unique identifiers against FPDS reference data (as illustrated in FIG. 9).
Step 7: Pentaho Analytics generates formatted data “Response” report with visualizations; report is stored into the Output folder (FIG. 10).
Step 8: Processing script picks up the “Response” report from the Output folder;
If report file size is smaller than 25 MB:
Step 9: User receives the personalized “Response” report via email
If report file size is larger than 25 MB:
Step 10: Personalized “Response” report is saved to an SFTP server
Step 11: User receives a notification email that their personalized report is ready; user retrieves the report from the SFTP server

The steps above are high level for illustrative purposes and are conceptually mapped to the processing steps described in FIG. 2 “Call and Response” (Asynchronous) Processing Architecture. Steps 1 and 2 are referred to Data Consumer and Internet or LAN. Steps 3 and 4 are referred to Request Processing Module. Step 5 to ETL Engine & Workflows. Step 6 to Data Call Engine. Step 6 to Data Repository. Steps 7 through 11 are referred to Data Response Engine.

For this illustrative embodiment, the technical architecture is comprised of:
Apache Tomcat—an open source Web server and servlet container.
MySQL—most popular open source database software. MySQL will store FPDS reference data, as well as input and output reports data.
Pentaho—open source business intelligence and data integration platform.
SFTP—secure file transfer protocol (for storing reports larger than 25 MB).
SMTP, IMAP—simple mail transport protocol and Internet Message Access Protocol—will be used for receiving e-mail(s) with the Excel input (“the Call”), and forward the personalized reports (“the Response”).

Centerpiece of this representative architecture is Pentaho—an open source comprehensive platform for data integration and analytics. Pentaho Data Integration is used to map stripped unique identifiers to the FPDS data elements Pentaho Business Analytics is used to generate a personalized report that includes visualizations (charts, maps, bars).

Pentaho Data Integration—delivers powerful data preparation capabilities including extract, transform and load (ETL). An intuitive and rich graphical design environment minimizes complexity and time invested in specialized scripts to prepare data. Features include:
Profiling—data profiling and data quality
Visualization—integrated semantic dimensional modeling and visualization enables iterative agile data integration and business analysis

Pentaho Business Analytics—is a tightly coupled business analytics platform that empowers business users to make information-driven decisions. Pentaho Business Analytics includes:
Reporting—from self-service interactive reporting, to high-volume, highly formatted enterprise reporting. Output formats include: PDF, Excel, HTML, CSV, and RTF
Interactive Dashboards—delivers key performance indicators to provide business users with the critical information they need to understand and improve performance
Mobile—provides business user on the go a true mobile experience with complete data discovery, interactive analysis, and visualization on the iPad or mobile device.

### Technical Deep Dive

“Calls” and “Responses”.

Once e-mail with Excel spreadsheet is received, computer program (script) processes the attachment, adding sender's e-mail address to the Excel spreadsheet. Pentaho ETL then saves unique identifiers (and sender's e-mail) from spreadsheet to database using same column names as FPDS. Unique identifiers are then matched to the FPDS database, and matched records are then sent to Pentaho Analytics to generate the report (or visualizations, if applicable). Generated file name use date/time stamp and sender's email appended to the name (e.g. 201307160810_fname.lname@abc.com). The processing script (step 8 above), parses file name, using the e-mail address from file name to return personalized report “Response” to sender.

SFTP Access.

SFTP access will be provided to allow users to download personalized reports larger than 25 MB. “Call and Response” solution will use a generic account for accessing the personalized reports. Each report will be saved in a date folder (e.g. 20130716) using a unique identifier for the report name. The later will be sent via e-mail to the requester of the report along with the e-mail notification that report is ready to be downloaded. If additional security (above using a shared SFTP account) is required, SFTP can be configured to use public key authentication. SFTP is an extension of Secure Shell protocol (SSH) to provide secure file transfer capability. SSH uses public-key cryptography to allow the remote computer to authenticate the user. Public key authentication is an alternative means of identifying user to a login server instead of typing a password.

Error Handling.

In the event of incomplete or erroneous request (such as non-Excel file attachment), or blank template is received, the system will send back to the user a friendly explanation email describing the issue, as well as a list of easy to follow actions for the user to follow.

For illustrative purposes, two examples of this embodiment are described below:

### Example 1

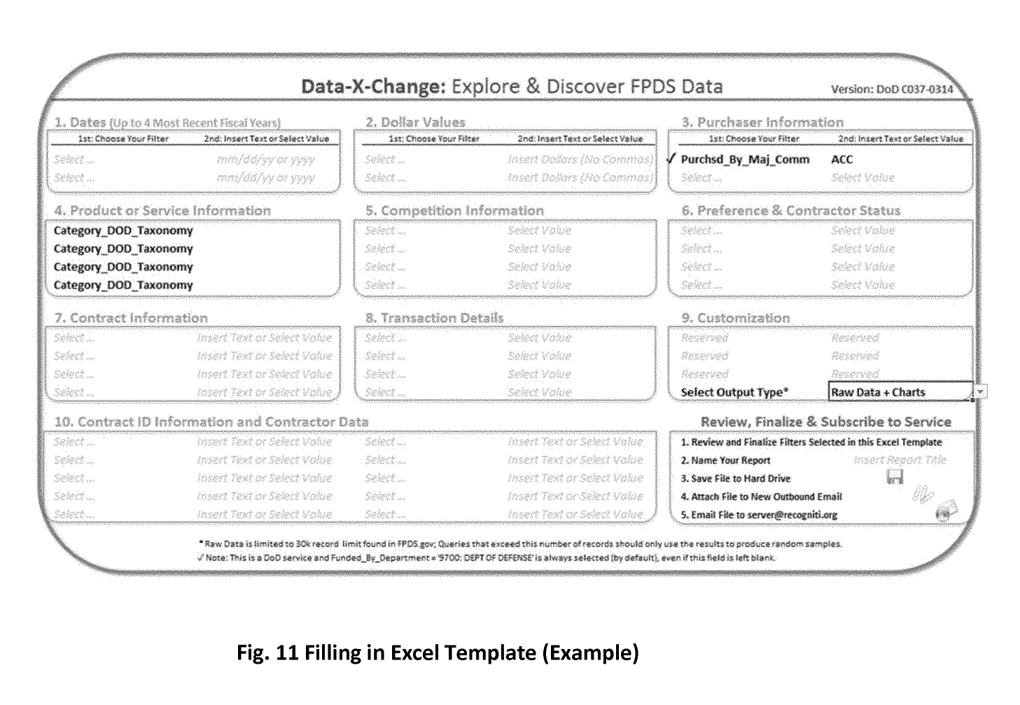

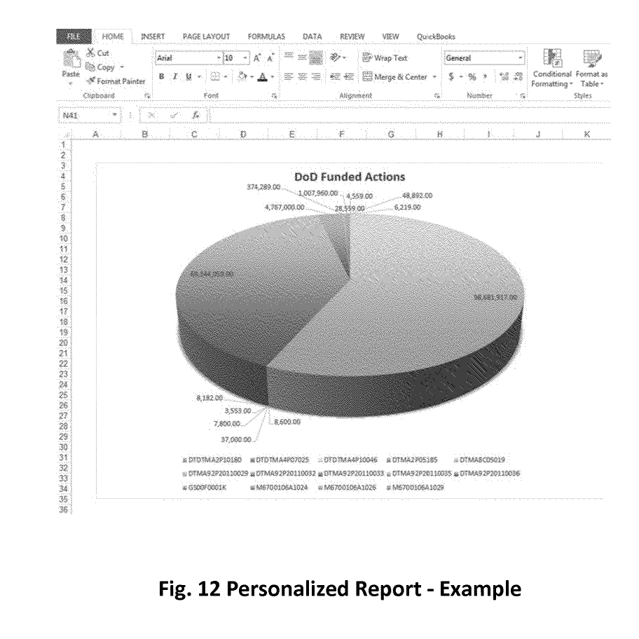

David is a Federal Agency Contracting Officer. He wants to see a report of Federal Agency funded Actions by Funding Agency. David uses an Excel template and enters the list of Funding Agencies, as shown on FIG. 11.
The input data is validated and David saves the Excel workbook. He e-mails it to: requests@callnreceive.com.
David receives an e-mail with a personalized report that includes Federal Agency Funded Actions for the list of contract number specified in the initial request. FIG. 12 below shows an example of the received spreadsheet.

### Example 2

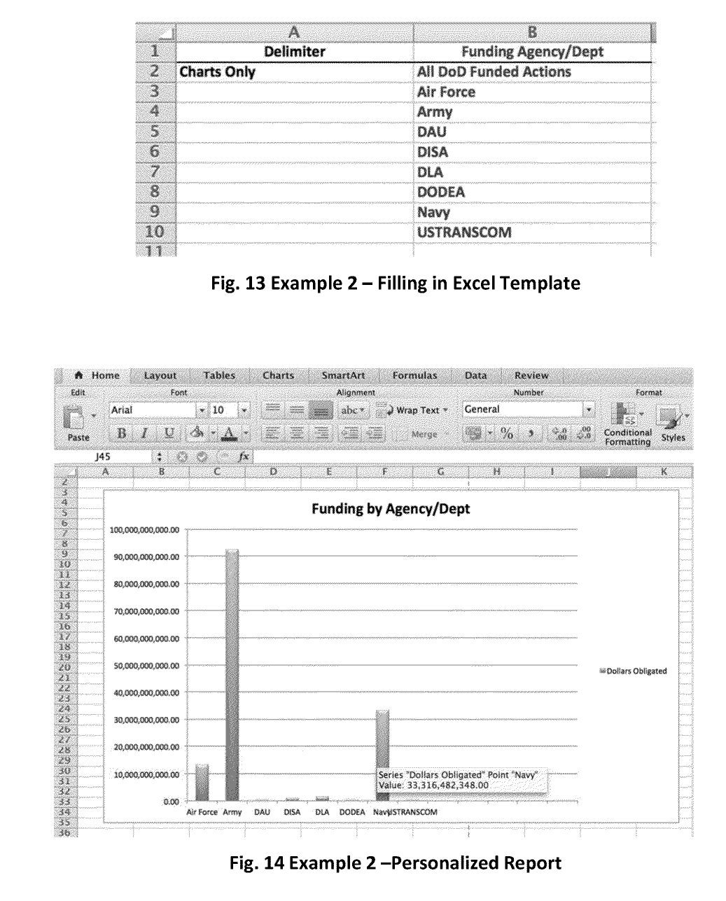

Mary is a Federal Agency Program Manager. Mary wants to review Dollars Obligated for several contracts. She uses the Excel template entering the Contract Numbers similar to the example shown on FIG. 13.
The input data is validated and Mary saves the Excel workbook. She e-mails it to: requests@callnreceive.com. Mary receives an e-mail with a personalized report that includes Dollars obligated by Federal Agency Agency/Department for the list of agencies and departments specified in the initial request. FIG. 14 shows an example of the received spreadsheet report.
In another embodiment, semantic technologies and SPARQL can be used in producing, processing, and utilizing additional (including government) datasets. This will enhance the application of the present invention by:
   Enriching the value of data via normalizing, linking, and information-extraction
   Realize the value of data by tapping into additional data sources
      The technical code is included below:

### Input Data Call:

```
package com.recogniti.pentaho.pbsdias.dao;
import java.io.Serializable;
import java.util.Date;
import java.util.HashSet;
import java.util.Set;
public class Request
  implements Serializable
{
      private Integer id;
      private Tenant tenant;
      private StatusOfRequest statusOfRequest;
      private String messageId;
      private Date receiveTime;
      private String filePathName;
      private Boolean withAttachment;
      private String subject;
      private String mesageText;
      private Date sentTime;
      private Float sizeOfFile;
      private String sftpLinkToFile;
      private Date timeOfGeneration;
      private String replyTo;
      private Set errorDescriptions = new HashSet(0);
      private Set excelSpreadsheetheads = new HashSet(0);
          public Request( ) { }
          public Request(Tenant tenant)
        {
            this.tenant = tenant;
          }
            public Request(Tenant tenant, StatusOfRequest statusOfRequest, String
messageId, Date receiveTime, String filePathName, Boolean withAttachment, String
subject, String mesageText, Date sentTime, Float sizeOfFile, String sftpLinkToFile,
Date timeOfGeneration, String replyTo, Set errorDescriptions, Set
excelSpreadsheetheads)
          {
            this.tenant = tenant;
            this.statusOfRequest = statusOfRequest;
            this.messageId = messageId;
            this.receiveTime = receiveTime;
            this.filePathName = filePathName;
            this.withAttachment = withAttachment;
            this.subject = subject;
    this.mesageText = mesageText;
    this.sentTime = sentTime;
    this.sizeOfFile = sizeOfFile;
    this.sftpLinkToFile = sftpLinkToFile;
    this.timeOfGeneration = timeOfGeneration;
    this.replyTo = replyTo;
    this.errorDescriptions = errorDescriptions;
    this.excelSpreadsheetheads = excelSpreadsheetheads;
  }
    public Integer getId( )
  {
    return this.id;
  }
    public void setId(Integer id)
  {
    this.id = id;
  }
    public Tenant getTenant( )
  {
    return this.tenant;
  }
    public void setTenant(Tenant tenant)
  {
    this.tenant = tenant;
  }
    public StatusOfRequest getStatusOfRequest( )
  {
    return this.statusOfRequest;
  }
    public void setStatusOfRequest(StatusOfRequest statusOfRequest)
  {
    this.statusOfRequest = statusOfRequest;
  }
    public String getMessageId( )
  {
    return this.messageId;
  }
    public void setMessageId(String messageId)
  {
    this.messageId = messageId;
  }
    public Date getReceiveTime( )
  {
    return this.receiveTime;
  }
    public void setReceiveTime(Date receiveTime)
  {
    this.receiveTime = receiveTime;
  }
    public String getFilePathName( )
  {
    return this.filePathName;
  }
    public void setFilePathName(String filePathName)
  {
    this.filePathName = filePathName;
  }
    public Boolean getWithAttachment( )
  {
    return this.withAttachment;
  }
    public void setWithAttachment(Boolean withAttachment)
  {
    this.withAttachment = withAttachment;
  }
    public String getSubject( )
  {
    return this.subject;
  }
    public void setSubject(String subject)
  {
    this.subject = subject;
  }
    public String getMesageText( )
  {
    return this.mesageText;
  }
    public void setMesageText(String mesageText)
  {
    this.mesageText = mesageText;
  }
    public Date getSentTime( )
  {
    return this.sentTime;
  }
    public void setSentTime(Date sentTime)
  {
    this.sentTime = sentTime;
  }
    public Float getSizeOfFile( )
  {
    return this.sizeOfFile;
  }
    public void setSizeOfFile(Float sizeOfFile)
  {
    this.sizeOfFile = sizeOfFile;
  }
    public String getSftpLinkToFile( )
  {
    return this.sftpLinkToFile;
  }
    public void setSftpLinkToFile(String sftpLinkToFile)
  {
    this.sftpLinkToFile = sftpLinkToFile;
  }
    public Date getTimeOfGeneration( )
  {
    return this.timeOfGeneration;
  }
    public void setTimeOfGeneration(Date timeOfGeneration)
  {
    this.timeOfGeneration = timeOfGeneration;
  }
  public String getReplyTo( )
  {
    return this.replyTo;
  }
    public void setReplyTo(String replyTo)
  {
    this.replyTo = replyTo;
  }
    public Set getErrorDescriptions( )
  {
    return this.errorDescriptions;
  }
    public void setErrorDescriptions(Set errorDescriptions)
  {
    this.errorDescriptions = errorDescriptions;
  }
    public Set getExcelSpreadsheetheads( )
  {
    return this.excelSpreadsheetheads;
  }
    public void setExcelSpreadsheetheads(Set excelSpreadsheetheads)
  {
    this.excelSpreadsheetheads = excelSpreadsheetheads;
  }
}
```

### Process Input:

```
package com.recogniti.pentaho.bw;
import com.recogniti.database.DatabaseHelper;
import com.recogniti.pentaho.bo.ExcelSpreadsheetheadBO;
import com.recogniti.pentaho.bo.QueryLogBO;
import com.recogniti.pentaho.bo.RequestBO;
import com.recogniti.pentaho.bo.SpreadsheetDetailsBO;
import com.recogniti.pentaho.bo.TemplateDescriptorBO;
import com.recogniti.pentaho.bo.TenantBO;
import com.recogniti.pentaho.bo.TplSqlBO;
import com.recogniti.pentaho.bo.TplTypeBO;
import com.recogniti.pentaho.bo.TplWhereBO;
import com.recogniti.pentaho.bo.ValuesBO;
import com.recogniti.pentaho.xslreader.NotAnExcelAttachmentException;
import java.io.BufferedOutputStream;
import java.io.File;
import java.io.FileInputStream;
import java.io.FileOutputStream;
import java.io.IOException;
import java.io.PrintWriter;
import java.io.StringWriter;
import java.math.BigDecimal;
import java.math.BigInteger;
import java.sql.Connection;
import java.sql.DatabaseMetaData;
import java.sql.SQLException;
import java.util.ArrayList;
import java.util.Calendar;
import java.util.Date;
import java.util.HashMap;
import java.util.Iterator;
import java.util.List;
import java.util.ListIterator;
import java.util.Map;
import java.util.Set;
import java.util.StringTokenizer;
import java.util.regex.Pattern;
import org.apache.commons.configuration.Configuration;
import org.apache.commons.lang.StringEscapeUtils;
import org.apache.commons.logging.Log;
import org.apache.poi.ss.usermodel.Cell;
import org.apache.poi.ss.usermodel.CellStyle;
import org.apache.poi.ss.usermodel.DataFormat;
import org.apache.poi.ss.usermodel.Row;
import org.apache.poi.ss.usermodel.Sheet;
import org.apache.poi.ss.usermodel.Workbook;
import org.apache.poi.xssf.streaming.SXSSFSheet;
import org.apache.poi.xssf.streaming.SXSSFWorkbook;
import org.apache.poi.xssf.usermodel.XSSFCell;
import org.apache.poi.xssf.usermodel.XSSFRow;
import org.apache.poi.xssf.usermodel.XSSFSheet;
import org.apache.poi.xssf.usermodel.XSSFWorkbook;
import org.hibernate.Session;
import org.hibernate.Transaction;
import org.hibernate.jdbc.ReturningWork;
import org.hibernate.jdbc.Work;
public class ReportGenerator
  extends BusinessWorkerAbstract
{
  DatabaseHelper databaseHelper;
  public ReportGenerator(Configuration config)
    throws Exception
  {
    super(config);
    this.databaseHelper = new DatabaseHelper(getConf( ));
  }
  public void process( )
    throws Exception
  {
    generatePentahoReport( );
    getRequest( ).setTimeOfGeneration(new Date( ));
  }
  public String getThreadJobText( )
  {
    return getRequest( ).getThreadJobText( );
  }
  private void generatePentahoReport( )
    throws Exception
  {
    TenantBO tenant = getRequest( ).getTenantBO( );
    ExcelSpreadsheetheadBO excelSpreadsheethead = getRequest( )
      .getExcelSpreadsheetheadBO( );
    List<SpreadsheetDetailsBO> spreadsheetDetails = excelSpreadsheethead
      .getSpreadsheetDetailsBO( );
    String whereOnly = buildWhereStr(spreadsheetDetails);
    String where = “1 = 1” + whereOnly;
    String repl = Pattern.quote(“{where}”);
    String reportName = excelSpreadsheethead.getReportName( );
    TemplateDescriptorBO templateDescriptorBO = new TemplateDescriptorBO(
      tenant).findByReportName(reportName):
    getLog( ).info(getThreadJobText( ) +
      “templateDescriptorBO ReportName ” + templateDescriptorBO.getReportName( ) +
      “\n templateDescriptorBO.id=” + templateDescriptorBO.getId( ));
    TplTypeBO tplTypeBO = new TplTypeBO( ).findByRef(
      templateDescriptorBO.getId( ).intValue( ),
      excelSpreadsheethead.getReportContentType( ));
    getLog( ).info(getThreadJobText( ) +
      “tplTypeBO id ” + tplTypeBO.getId( ));
    List<TplSqlBO> tplSqlBOList = new TplSqlBO( ).findByRef(tplTypeBO
      .getId( ).intValue( ));
    String reportTemplate = tplTypeBO.getPentahoReportTemplateFile( );
    String templateFilePathName = tenant.getReportTplFolder( ) +
      File.separator + reportTemplate;
    String outFileNamePathOfReport = getRequest( ).getFilePathName( );
    FileOutputStream excelReportFileOut = new FileOutputStream(
      outFileNamePathOfReport);
    BufferedOutputStream bufOS = new BufferedOutputStream(
      excelReportFileOut);
    FileInputStream excelReportTemplateFile = new FilelnputStream(new File(
      templateFilePathName));
    try
    {
      XSSFWorkbook xssfWorkbook = new XSSFWorkbook(excelReportTemplateFile);
      SXSSFWorkbook excelWorkbookTemplate = new SXSSFWorkbook(xssfWorkbook);
      excelWorkbookTemplate.setCompressTempFiles(true);
    }
    catch (IllegalArgumentException e)
    {
      throw new NotAnExcelAttachmentException(e);
    }
    XSSFWorkbook xssfWorkbook;
    SXSSFWorkbook excelWorkbookTemplate;
    String title = getRequest( ).getExcelSpreadsheetheadBO( )
      .getReportTitle( );
    storeWhereAndName(xssfWorkbook, whereOnly, title);
    String sheetnameRowData = tplTypeBO.getRawDataSheetName( ):
    String sheetnameMapping = tplTypeBO.getColumnMappingSheetName( );
    SXSSFSheet excelSheetnameRowData = (SXSSFSheet)excelWorkbookTemplate
      .getSheet(sheetnameRowData);
    excelSheetnameRowData.setRandomAccessWindowSize(1000);
    XSSFSheet excelSheetnameMapping = xssfWorkbook.getSheet(sheetnameMapping);
    if (excelSheetnameRowData == null)
    {
      getLog( ).error(getThreadJobText( ) +
        “Required sheet named ” + sheetnameRowData +
        “ is not found.”);
      throw new Exception(“Required sheet named ” + sheetnameRowData +
        “ is not found.”);
    }
    if (excelSheetnameMapping == null)
    {
      getLog( ).error(getThreadJobText( ) +
        “Required sheet named ” + sheetnameMapping +
        “ is not found.”);
      throw new Exception(“Required sheet named ” + sheetnameMapping +
        “ is not found.”);
    }
    XSSFSheet rawdataRO = xssfWorkbook.getSheet(sheetnameRowData);
    HashMap<String, String> map_dbToExcelcolumnName = new HashMap( );
    for (int j = 0; j <= excelSheetnameMapping.getLastRowNum( ); j++)
    {
      Row row = excelSheetnameMapping.getRow(j);
      if ((row != null) && (row.getCell(1) != null) && (row.getCell(2) != null))
      {
        if (map_dbToExcelcolumnName.get(row.getCell(2).getStringCellValue( ).trim( )) !=
  null) {
          getLog( ).warn(“FieldMapping Description column value ” +
            row.getCell(2).getStringCellValue( ).trim( ) + “ is duplicated.”);
        }
        map_dbToExcelcolumnName.put(row.getCell(2).getStringCellValue( )
          .trim( ), row.getCell(1).getStringCellValue( ).trim( ));
      }
    }
    HashMap<String, Integer> map_excelcolumnNameToExcelcolumnNumber = new HashMap( );
    for (int j = 0; j <= rawdataRO.getRow(0).getLastCellNum( ); j++) {
      if (rawdataRO.getRow(0).getCell(j) != null)
      {
        if (map_excelcolumnNameToExcelcolumnNumber
          .get(rawdataRO.getRow(0).getCell(j)
          .getStringCellValue( ).trim( )) != null) {
          getLog( ).warn(“RowData column name ” +
            rawdataRO.getRow(0).getCell(j)
            .getStringCellValue( ).trim( ) + “ is duplicated.”);
        }
        map_excelcolumnNameToExcelcolumnNumber.put(rawdataRO.getRow(0).getCell(j)
          .getStringCellValue( ).trim( ), new Integer(j));
      }
    }
    getLog( ).warn(getThreadJobText( ) +
      “List of sqls start:”);
    for (TplSqlBO tplSqlBO : tplSqlBOList)
    {
      String dataset = tplSqlBO.getPentahoDataSetName( );
      String sql = tplSqlBO.getSqlStr( );
      sql = sql.replaceAll(repl, where);
      getLog( ).warn(getThreadJobText( ) +
        sql);
      getLog( ).warn(getThreadJobText( ) + “Database URL before commit: ” +
        retreiveConnectionURL1(getRequest( ).getSession( )));
      getRequest( ).getSession( ).getTransaction( ).commit( );
      List<Map<String, Object>> fpdsValueMapList = this.databaseHelper
        .executeSQLtoColumnNamesMap(sql);
      getRequest( ).getSession( ).beginTransaction( );
      try
      {
        copyResultSetsIntoExcelSheet(fpdsValueMapList,
          map_dbToExcelcolumnName,
          map_excelcolumnNameToExcelcolumnNumber,
          excelSheetnameRowData, excelSheetnameMapping);
      }
      catch (IllegalArgumentException e)
      {
        copyResultSetsIntoExcelSheet(fpdsValueMapList,
          map_dbToExcelcolumnName,
          map_excelcolumnNameToExcelcolumnNumber, rawdataRO,
          excelSheetnameMapping);
      }
    }
    getLog( ).warn(getThreadJobText( ) +
      “List of sqls end.”);
    excelWorkbookTemplate.setForceFormulaRecalculation(true);
    excelWorkbookTemplate.write(excelReportFileOut);
    excelReportFileOut.close( );
    excelWorkbookTemplate.dispose( );
    File file = new File(outFileNamePathOfReport);
    String msgWithAttachment = getConf( ).getString(“msgWithAttachment”);
    if ((msgWithAttachment == null) | | (msgWithAttachment.equals(“”))) {
      msgWithAttachment = “Please, find attached your personalized response report.
This service is in testing and data may be inaccurate or incomplete.”;
    }
    String msgWithSftpLink = getConf( ).getString(“msgWithSftpLink”);
    if ((msgWithSftpLink == null) | | (msgWithSftpLink.equals(“”))) {
      msgWithSftpLink = “This service is in testing and data may be inaccurate or
incomplete. The result is larger than {attachmentSizeMB}MB To get response of Your
request follow this link:”;
    }
    long space = file.length( );
    getRequest( ).setSizeOfFile(Float.valueOf((float)space * 1.0F));
    int attachmentSize = getConf( ).getInt(“attachmentSizeMB”);
    if (attachmentSize == 0) {
      attachmentSize = 25;
    }
    if (space > attachmentSize * 1024 * 1024)
    {
      moveToSFTP( );
      getRequest( ).setWithAttachment(Boolean.valueOf(false));
      msgWithSftpLink = msgWithSftpLink.replace(“{attachmentSizeMB}”, attachmentSize);
      getRequest( )
        .setMesageText(msgWithSftpLink);
    }
    else
    {
      getRequest( ).setWithAttachment(Boolean.valueOf(true));
      getRequest( )
        .setMesageText(msgWithAttachment);
    }
  }
  private void storeWhereAndName(XSSFWorkbook xssfWorkbook, String whereOnly, String
title)
  {
    String formatedWhereOnly = new String(whereOnly).replace(“AND ”, “AND \r\n”);
    XSSFSheet firstSheet = xssfWorkbook.getSheet(“SelectionCriteria”);
    if (firstSheet == null) {
      firstSheet = xssfWorkbook.getSheetAt(0);
    }
    XSSFRow secondRow = firstSheet.getRow(1);
    if (secondRow == null) {
      secondRow = firstSheet.createRow(1);
    }
    XSSFCell secondCell = secondRow.getCell(1);
    if (secondCell == null) {
      secondCell = secondRow.createCell(1);
    }
    secondCell.setCellValue(title);
    XSSFRow sixth = firstSheet.getRow(5);
    if (sixth == null) {
      sixth = firstSheet.createRow(5);
    }
    secondCell = sixth.getCell(1);
    if (secondCell == null) {
      secondCell = secondRow.createCell(1);
    }
    secondCell.setCellValue(formatedWhereOnly);
  }
  private void copyResultSetsIntoExcelSheet(List<Map<String, Object>>
fpdsValueMapList, HashMap<String, String> map_dbToExcelcolumnName, HashMap<String,
Integer> map_excelcolumnNameToExcelcolumnNumber, Sheet excelSheetnameRowData, Sheet
excelSheetnameMapping)
    throws OException
  {
    DataFormat format = excelSheetnameRowData.getWorkbook( ).createDataFormat( );
    CellStyle styleDate = excelSheetnameRowData.getWorkbook( ).createCellStyle( );
    styleDate.setDataFormat(format.getFormat(“M/D/YY;@”));
    CellStyle styleInt = excelSheetnameRowData.getWorkbook( ).createCellStyle( );
    styleInt.setDataFormat(format.getFormat(“0”));
    int wrcount = 1000;
    for (int row = 0; row < fpdsValueMapList.size( ); row++)
    {
      Map<String, Object> fpdsRowMap = (Map)fpdsValueMapList.get(row);
      Iterator db_columNames = fpdsRowMap.keySet( ).iterator( );
      int col = 0;
      if (row >= wrcount)
      {
        getLog( ).warn(getThreadJobText( ) +
          “Rows in excel --> ” + row);
        wrcount += 1000;
      }
      while (db_columNames.hasNext( ))
      {
        String db_columname = (String)db_columNames.next( );
        Object value = fpdsRowMap.get(db_columname);
        String excelcolumnName =
          (String)map_dbToExcelcolumnName.get(db_columname.trim( ));
        if (excelcolumnName != null)
        {
          Integer cInteger =
            (Integer)map_excelcolumnNameToExcelcolumnNumber.get(excelcolumnName);
          if (cInteger != null)
          {
            col = cInteger.intValue( );
            Row row2 = excelSheetnameRowData.getRow(row + 1);
            if (row2 == null) {
              row2 = excelSheetnameRowData.createRow(row + 1);
            }
            Cell cell = row2.getCell(col);
            if (cell == null) {
              cell = row2.createCell(col);
            }
            if ((value instanceof Double))
            {
              cell.setCellValue(((Double)value).doubleValue( ));
            }
            else if ((value instanceof String))
            {
              cell.setCellValue((String)value);
            }
            else if ((value instanceof Date))
            {
              cell.setCellValue((Date)value);
              cell.setCellStyle(styleDate);
            }
            else if ((value instanceof BigInteger))
            {
              cell.setCellValue(((BigInteger)value)
                .doubleValue( ));
            }
            else if ((value instanceof Integer))
            {
              cell.setCellValue(((Integer)value).doubleValue( ));
            }
            else if ((value instanceof BigDecimal))
            {
              cell.setCellValue(((BigDecimal)value)
                .doubleValue( ));
            }
            else if ((value instanceof Character))
            {
              cell.setCellValue((Character)value);
            }
            else
            {
              Class cls = null;
              String clsName = “<Null>”:
              if (value != null)
              {
                cls = value.getClass( );clsName = cls.getName( );
              }
              if (value != null)
                getLog( ).error(getThreadJobText( ) +
                  “Unrecognized cell type ” + clsName + “ --> ” + value);
              }
            }
          }
          else
          {
            getLog( ).warn(“Excel column name ” + excelcolumnName +
              “ is not in mapping.”);
          }
        }
        else
        {
          getLog( ).warn(“SQL column name ” + db_columname +
            “ is not in mapping.”);
        }
      }
    }
  }
  private String buildWhereStr(List<SpreadsheetDetailsBO> spreadsheetDetails)
    throws Exception
  {
    HashMap<String, String> eqDefMap = new HashMap( );
    eqDefMap.put(“in”, “=”);
    eqDefMap.put(“gr”, “>”);
    eqDefMap.put(“greq”, “>=”);
    eqDefMap.put(“le”, “<”);
    eqDefMap.put(“leeq”, “<=”);
    eqDefMap.put(“like”, “like”);
    HashMap<String, String> columnMap = new HashMap( );
    HashMap<String, String> eqMap = new HashMap( );
    HashMap<String, String> typeMap = new HashMap( );
    HashMap<String, String> fmtMap = new HashMap( );
    ArrayList<TplWhereBO> tplWhereBOList = new TplWhereBO( )
      .findAllTplWhere( );
    for (int i = 0; i < tplWhereBOList.size( ); i++)
    {
      TplWhereBO tplWhereBO = (TplWhereBO)tplWhereBOList.get(i);
      columnMap.put(tplWhereBO.getExcelColumnName( ),
        tplWhereBO.getFpdsColumnName( ));
      eqMap.put(tplWhereBO.getExcelColumnName( ), tplWhereBO.getEq( ));
      typeMap.put(tplWhereBO.getExcelColumnName( ),
        tplWhereBO.getFpdsColumnType( ));
      fmtMap.put(tplWhereBO.getExcelColumnName( ),
        tplWhereBO.getParseToTypeFmt( ));
    }
    String where = “”;
    for (int i = 0; i < spreadsheetDetails.size( ); i++)
    {
      SpreadsheetDetailsBO spreadsheetDetailsBO =
        (SpreadsheetDetailsBO)spreadsheetDetails.get(i);
      String excolumn = spreadsheetDetailsBO.getExcelColumnName( );
      if (!columnMap.containsKey(excolumn))
      {
        getLog( ).warn(getThreadJobText( ) +
          “The column ------ ” + excolumn +
          “ ------- has no mapping in tplwhere!”);
      }
      else
      {
        if (!eqMap.containsKey(excolumn)) {
          throw new Exception(“Invalid column name: ” + excolumn);
        }
        String column = (String)columnMap.get(excolumn);
        String eq = ((String)eqMap.get(excolumn)).toLowerCase( );
        String eq_UpperCase = ((String)eqMap.get(excolumn)).toUpperCase( );
        String eq_CaseSensitive = (String)eqMap.get(excolumn);
        String column_type = (String)typeMap.get(excolumn);
        String column fmt = (String)fmtMap.get(excolumn);
        List<ValuesBO> values = spreadsheetDetailsBO.getValuesBO( );
        String column values = “”;
        String and = “”;
        String values comma = “”;
        String sign = egDefMap.containsKey(eq) ? (String)eqDefMap.get(eq) : “ = ”;
        int found = 0;
        for (int j = 0; j < values.size( ); j++)
        {
          ValuesBO valuesBO = (ValuesBO)values.get(j);
          String value = valuesBO.getValue( );
          if ((value != null) && (value.trim( ).length( ) != 0))
          {
            List list = null;
            value = fmtVal(value, column_type, column_fmt);
            if (eq_UpperCase.equals(eq_CaseSensitive))
            {
              String query = “SELECT 1 FROM ” +
                getConf( ).getString(“contractsTable”) + “\tWHERE ” +
                column + “ ” + sign + “ ” + value + “ LIMIT 0, 1 ”;
              getLog( ).warn(getThreadJobText( ) +
                “The validation sql for column ” + column + “ is <” + query + “>.”);
              list = this.databaseHelper.executeSQL(query);
              getLog( ).warn(getThreadJobText( ) +
                “The validation <” + eq_CaseSensitive + “> for column ” + column + “/”
+ excolumn + “ return <” + (
                (list != null) && (list.listIterator( ).hasNext( )) ?
list.listIterator( ).next( ) : “ null ”) +
                “> value.”);
              if ((list == null) | | (list.size( ) == 0))
              {
                QueryLogBO qbo = new QueryLogBO( );
                qbo.setValuesBO(valuesBO);
                qbo.setLogText(“The value ’” + value + “‘ in column\t’” +
                  excolumn + “‘ is not valid!”);
                valuesBO.setQueryLogBO(qbo);
                if (values.size( ) == 1)
                {
                  found = 0;
                  break;
                }
              }
            }
            else
            {
              getLog( ).warn(getThreadJobText( ) +
                “The validation <” + eq_CaseSensitive + “> for column ” + column + “
was skipped.”);
            }
            if (list != null) {
              list.clear( );
            }
            list = null;
            if (“in”.equalsIgnoreCase(eq))
            {
              column_values = column_values + values_comma + “ ” + value + “ ”;
              values_comma = “,”;
            }
            else
            {
              column_values =
                column_values + and + “ ” + column + “ ” + sign + “ ” + value + “ ”;
              and = “ AND ”;
            }
            found++;
          }
        }
        if (found > 0) {
          if (“in”.equalsIgnoreCase(eq)) {
            where = where + “ AND ” + column + “ IN (“ + column_values + ”)”;
          } else {
            where = where + “ AND (“ + column_values + ”)”;
          }
        }
      }
    }
    return where;
  }
  private String fmtVal(String val, String type, String fmt)
    throws Exception
  {
    HashMap<String, String> parserMap = new HashMap( );
    parserMap.put(“date”, “STR_TO_DATE(‘{value}’, ‘{format}’)”);
    try
    {
      parserMap.put(“numeric”, val.substring(0, val.indexOf(“:”)));
    }
    catch (Exception localException) {}
    try
    {
      Integer i = Integer.valueOf(0);
      try
      {
        i = Integer.valueOf(fmt);
      }
      catch (Exception localExceptionl) { }
      if (i.intValue( ) == 0) {
        parserMap.put(“leftsubstring”, “‘“ + val.substring(0, val.indexOf(fmt)) +
”’”);
      } else {
        parserMap.put(“leftsubstring”, “‘” + val.substring(0, i.intValue( )));
      }
    }
    catch (Exception localException2) { }
    if (parserMap.containsKey(type))
    {
      String ptrn = (String)parserMap.get(type);
      String repl value = Pattern.quote(“{value}”);
      String repl_fmt = Pattern.quote(“{format}”);
      return ptrn.replaceAll(repl_value, val).replaceAll(repl_fmt, fmt);
    }
    return “‘“ + StringEscapeUtils.escapeSql(val.trim( )) + ”’”;
  }
  private void moveToSFTP( )
    throws Exception
  {
    String sftpPath = getRequest( ).getTenantBO( ).getSftpFolder( );
    String sFTPLink = getRequest( ).getTenantBO( ).getSftpUrlPrefix( );
    String filepath = getRequest( ).getFilePathName( );
    Calendar date = Calendar.getInstance( );
    String datePart = date.get(1) + “-” +
      date.get(2) + “-” +
      date.get(5);
    sftpPath = sftpPath + File.separator + datePart;
    File dir = new File(sftpPath);
    if (!dir.exists( ))
      dir.mkdir( );
    }
    StringTokenizer tokens = new StringTokenizer(filepath, File.separator);
    String fileName = null;
    while (tokens.hasMoreElements( )) {
      fileName = tokens.nextToken( );
    }
    new File(filepath).renameTo(new File(dir.getPath( ) + File.separator +
      fileName));
    getRequest( ).setSftpLinkToFile(
      sFTPLink + “/” + datePart + “/” + fileName);
  }
  public void printConnectionURL(Session session)
  {
    try
    {
      session.doWork(new Work( )
      {
        public void execute(Connection conn)
          throws SQLException
        {
          ReportGenerator.this.getLog( ).warn(“Database URL: ” +
conn.getMetaData( ).getURL( ));
        }
      });
    }
    catch (Exception e)
    {
      getLog( ).warn(“Database URL: ” + getStackTrace(e));
    }
  }
  public String retreiveConnectionURL1(Session session)
  {
    String url = “Database URL1:”;
    try
    {
      url = url + (String)session.doReturningWork(new ReturningWork( )
      {
        public String execute(Connection conn)
          throws SQLException
        {
          return conn.getMetaData( ).getURL( );
        }
      });
    }
    catch (Exception e)
    {
      url = url + “ \n ” + getStackTrace(e);
    }
    return url;
  }
  public String getStackTrace(Exception e)
  {
    StringWriter errors = new StringWriter( );
    e.printStackTrace(new PrintWriter(errors));
    return errors.toString( );
  }
}
```

Integration with eCommerce Application (for illustrative purposes, integration with CS-Cart Multivendor is demonstrated below)

### Add-on

```
<?xml version=“1.0”?>
<addon scheme=“2.0”>
      <id>fpds_crstatus</id>
      <name>Call and response service status</name>
      <description>Call and response service status</description>
      <version>1.0</version>
      <priority>200500</priority>
      <status>active</status>
</addon>
func
<?php
/***************************************************************************
* fpds_crstatus *
function fn_fpds_crstatus_change_order_status(
$status_to, $status_from, $order_info,
$force_notification, $order_statuses, $place_order)
{
error_log(“\n The Function fn_fpds_crstatus_change_order_status is called ”, 3,
“/home/ec2-user/out/error_log_fpds_crstatus.txt”);
}
****************************************************************************/
if ( !defined(‘AREA’) ) { die(‘Access denied’); }
function fn_fpds_crstatus_change_order_status($status_to, $status_from, $order_info,
$force_notification, $order_statuses, $place_order)
{
      $filename_error_log=“/home/ec2-user/out/error_log_fpds_crstatus.txt”;
      $fpds_request =$_REQUEST;
      $export_fpds_request = var_export($fpds_request, true);
      error_log(“export_fpds_request $export_fpds_request\n”, 3,
$filename_error_log);
      error_log(“The Function fn_fpds_crstatus_change_order_status is called : ”.
date(“Y/m/d”). “ ”. date(“h:i:sa”).“ \n”, 3,
      $filename_error_log);
        error_log(“status_from $status_from\n”, 3, $filename_error_log);
        error_log(“status_to $status_to \n”, 3, $filename_error_log);
            $payment_datetime = $order_info[‘timestamp’]; //time( );
            $payment_datetime_str = fn_date_format($payment_datetime, “%Y-%m-%d
%H:%M:%S”);
            $email= $order_info[‘email’];
            $domain = substr($order_info[‘email’], strpos($order_info[‘email’], ‘@’) +1);
            $order_id = $order_info[‘order_id’];
            $order_timestamp = time( ); //$order_info[‘timestamp’];
            $order_timestamp_str = fn_date_format($order_timestamp, “%Y-%m-%d
%H:%M:%S”);
              error_log(“email $email\n”, 3, $filename_error_log);
              error_log(“domain $domain\n”, 3, $filename_error_log);
              error_log(“payment_datetime $payment_datetime\n”, 3,
$filename_error_log);
              error_log(“payment_datetime $payment_datetime_str\n”, 3,
$filename_error_log);
              error_log(“order_id $order_id\n”, 3, $filename_error_log);
              error_log(“order_timestamp $order_timestamp\n”, 3, $filename_error_log);
              error_log(“order_timestamp $order_timestamp_str\n”, 3,
$filename_error_log);
              foreach ($order_info[‘products’] as $key => $product) {
                  $product_id=$product[‘product_id’] ;
                  $product_code = $product[‘product_code’];
                    error_log(“product_id $product_id\n”, 3, $filename_error_log);
                    error_log(“product_code $product_code\n”, 3,
$filename_error_log);
                  $custom_fields = db_get_array(“SELECT pod.option_name,
pod.description FROM ?:products as p LEFT JOIN ?:product_options as po on
p.product_id=po.product_id LEFT JOIN ?:product_options_descriptions as pod on
pod.option_id=po.option_id where p.product_id=?i”, $product_id);
                  foreach ( $custom_fields as $fields) {
                        if ( $fields[‘option_name’] == ‘Duration’) {
                              $duration = trim(strip_tags($fields[‘description’]));
                        }elseif ( $fields[‘option_name’] == ‘Service’) {
                              $service = trim(strip_tags($fields[‘description’]));
                        }elseif ( $fields[‘option_name’] == ‘Access’) {
                              $access = trim(strip_tags($fields[‘description’]));
                        }
                  }
                    error_log(“duration $duration\n”, 3, $filename_error_log);
                    error_log(“service $service\n”, 3, $filename_error_log);
                    error_log(“access $access\n”, 3, $filename_error_log);
                  if ($access == ‘Site’) {
                        $mail_from = $domain;
                  } else {
                        $mail_from = $email;
                  }
                    error_log(“mail_from $mail_from\n”, 3, $filename_error_log);
                  $end_date = $payment_datetime + ($duration * 24 * 60 * 60);
                    error_log(“end_date $end_date\n”, 3, $filename_error_log);
                  $end_date_str = fn_date_format(Send_date, “%Y-%m-%d %H:%M:%S”);
                    error_log(“end_date $end_date_str\n”, 3, $filename_error_log);
                  $current_status_timestamp = time( );
                  $current_status_timestamp_str =
fn_date_format($current_status_timestamp, “%Y-%m-%d %H:%M:%S”);
                  $current_status =
fn_fpds_crstatus_current_status_recalculation($product_code, $payment_datetime,
$end_date, $status_to, $current_status_timestamp);
                    error_log(“current_status $current_status\n”, 3,
$filename_error_log);
                  //Checked for old email or domain in DB
                  $db_mails = db_get_fields(“SELECT fa.mail_from FROM
?:fpds_authorizations fa WHERE fa.mail_from = ?s AND fa.product_code = ?s”,
$mail_from, $product_code):
                  if (!empty($db_mails)) {
                        foreach ($db_mails as $db_mail) {
                              db_query(
                                          “UPDATE ?:fpds_authorizations SET
current_status = ?i, access = ?s, service = ?s, product_code = ?s, start_date = ?i,
end_date = ?i, order_status = ?s, order_status_timestamp = ?i,
current_status_timestamp = ?i WHERE mail_from = ?s AND product code = ?s”,
                                          $current_status, $access, $service,
$product_code, $payment_datetime, $end_date, $status_to, $order_timestamp,
$current_status_timestamp, $db_mail, $product_code
                                          );
                              error_log(“UPDATE fpds:\nmail_from: $db_mail\n”, 3,
$filename_error_log);
                              error_log(“product_code $product_code\n”, 3,
$filename_error_log);
                              error_log(“access $access\n”, 3,
$filename_error_log);
                              error_log(“service $service\n”, 3,
$filename_error_log);
                              error_log(“current_status $current_status\n”, 3,
$filename_error_log);
                              error_log(“payment_datetime $payment_datetime_str\n”,
3, $filename_error_log);
                              error_log(“end_date $end_date_str\n”, 3,
$filename_error_log);
                        }
                  } else {
                        //Insert new email or domain
                        db_query(“INSERT INTO ?:fpds_authorizations (tenantid,
mail_from, reason_for_status, current_status, access, service, product_code,
start_date, end_date, order_id, order_status_timestamp, order_status, order_date,
duration, current_status_timestamp) VALUES (?i, ?s, ?s, ?i, ?s, ?s, ?s, ?i, ?i, ?i,
?i, ?s, ?i, ?i, ?i)”, 1, $mail_from, NULL, $current_status, $access, $service,
$product_code, $payment_datetime, $end_date, $order_id, $order_timestamp, $status_to,
$payment_datetime, $duration, $current_status_timestamp);
                        error_log(“INSERT:\nmail_from: $mail_from\n”, 3,
$filename_error_log);
                        error_log(“product_code $product_code\n”, 3,
$filename_error_log);
                        error_log(“access $access\n”, 3, $filename_error_log);
                        error_log(“service $service\n”, 3, $filename_error_log);
                        error_log(“current_status $current_status\n”, 3,
$filename_error_log);
                        error_log(“payment_datetime $payment_datetime_str\n”, 3,
$filename_error_log);
                        error_log(“end_date $end_date_str\n”, 3,
$filename_error_log);
                        error_log(“order_id $order_id\n”, 3, $filename_error_log);
                        error_log(“order_timestamp $order_timestamp\n”, 3,
$filename_error_log);
                        error_log(“order_timestamp $order_timestamp_str\n”, 3,
$file_name_error_log);
                        error_log(“status_to $status_to\n”, 3,
$filename_error_log);
                        error_log(“order_date $order_timestamp\n”, 3,
$filename_error_log);
                        error_log(“duration $duration\n”, 3, $filename_error_log);
                        error_log(“current_status_timestamp
$current_status_timestamp\n”, 3, $filename_error_log);
                        error_log(“current_status_timestamp
$current_status_timestamp_str\n”, 3, $filename_error_log);
                }
            }
      return true;
}
/**
  * Calculate current status
  */
function fn_fpds_crstatus_current_status_recalculation($product_code, $start_date,
$end_date, $status_to, $current_date_time) {
      $authorized_product_codes = db_get_array(“SELECT p.product_code FROM ?:products
as p WHERE p.product_code NOT LIKE ‘%TRY7’ ”);
      $trialactive_product_codes = db_get_array(“SELECT p.product_code FROM
?:products as p WHERE p.product_code LIKE ‘%TRY7’ ”);
      $current_status = 6; //‘unknown’
      $status = 0; //‘unknown’
      foreach ($authorized_product_codes as $code_authorized) {
            if ($product_code == $code_authorized[‘product_code’]) {
                  $status = 1; //‘authorized’
                  break;
            }
      }
      foreach ($trialactive_product_codes as $code_trialactive) {
            if ($product_code == $code_trialactive[product_code’]) {
                  $status = 2; //‘trialactive’
                  break;
            }
      }
      if ( $status == 1 && ($start_date <= $current_date_time && $current_date_time
<= $end_date)) {
            $current_status = 1; //‘authorized’
      } elseif ( $status == 2 && ($start_date <= $current_date_time &&
$current_date_time <= $end_date)) {
            $current_status = 2; //‘trialactive’
      } elseif ($status == 2 && !($start_date <= $current_date_time &&
$current_date_time <= $end_date)) {
            $current_status = 3; //‘trialinactive’
      } elseif ($status == 1 && !($start_date <= $current_date_time &&
$current_date_time <= $end_date)) {
            $current_status = 4; //‘unauthorized’
      }
      if ($status_to <> ‘P’) {
            $current_status = 5; //blocked
      }
      return $current_status;
}
?>
```

### Init

<?php
/************************************************************

| | |
|---|---|
| * Status of call and response service fpds_crstatus | * |

***********************************************************/
if ( !defined(‘AREA’) ) { die(‘Access denied’); }
/* fn_register_hooks( ‘change_order_status’);*/
fn_register_hooks(
‘change_order_status’
);
?>

### Backend

```
<?php
use Tygh\Pdf;
use Tygh\Registry;
if (!defined(‘BOOTSTRAP’)) { die(‘Access denied’); }
if ($_SERVER[‘REQUEST_METHOD’] == ‘POST’) {
    $suffix = ‘.manage’;
      $filename_error_log =“/home/ec2-user/out/error_log_fpds_crstatus.txt”;
      error_log(“fpds_callresponce_authorization.php\n”, 3, $filename_error_log);
      $shipments_request =$_REQUEST;
      $export_shipments_request = var_export($shipments_request, true);
      error_log(“export_fpds_callresponce_authorization.php_request
$export_shipments_request\n”, 3, $filename_error_log);
      $order_id = $_REQUEST[‘shipment_data’][‘order_id’];
      $admin_payment_date_str = $_REQUEST[‘admin_payment_date’];
      error_log(“admin_payment_date_str $admin_payment_date_str\n”, 3,
$filename_error_log);
      $admin_payment_date = strtotime($admin_payment_date_str);
      error_log(“admin_payment_date $admin_payment_date\n”, 3, $filename_error_log);
      $comments = $_REQUEST[‘shipment_data’][‘comments’];
      error_log(“comments $comments\n”, 3, $filename_error_log);
      $shipment = $_REQUEST[‘shipment_data‘];
      $order_info = fn_get_order_info($order_id, false, true, true);
      foreach ($order_info[‘products’] as $item_id => $item) {
            $order_info_item_id = $item[item_id];
            error_log(“order_info_item_id $order_info_item_id\n”, 3,
$filename_error_log);
            $shipment_product_number = $shipment[‘products’][$order_info_item_id];
            error_log(“shipment_product_number $shipment_product_number\n”, 3,
$filename_error_log);
            if ($shipment_product_number == 1) {
                  $product_code = $item[‘product_code’];
                  db_query(
                              “UPDATE ?:fpds_authorizations SET
authorization_date_manually = ?i, description_date_manually = ?s WHERE order_id = ?i
AND product_code = ?s”,
                              $admin_payment_date, $comments, $order_id,
$product_code
                              );
                  error_log(“UPDATE date_manually\n order_id $order_id\n”, 3,
$filename_error_log);
                    error_log(“product_code $product_code\n”, 3, $filename_error_log);
                    error_log(“admin_payment_date $admin_payment_date\n”, 3,
$filename_error_log);
                    error_log(“admin_payment_date_str $admin_payment_date_str\n”, 3,
$filename_error_log);
                    error_log(“comments $comments\n”, 3, $filename_error_log);
              }
      }
    if ($mode == ‘add’ && !empty($_REQUEST[‘shipment_data’]) &&
!fn_allowed_for(‘ULTIMATE:FREE’)) {
        $force_notification = fn_get_notification_rules($_REQUEST);
        fn_update_shipment($_REQUEST[‘shipment_data’], 0, 0, false,
$force_notification);
        $suffix = ‘.details?order_id =’. $_REQUEST[‘shipment_data’][‘order_id’];
    }
    if ($mode == ‘packing_slip’ && !empty($_REQUEST[‘shipment_ids’])) {
        fn_print_shipment_packing_slips($_REQUEST[‘shipment_ids’],
Registry::get(‘runtime.dispatch_extra’) == ‘pdf’);
        exit;
    }
    if ($mode == ‘m_delete’ && !empty($_REQUEST[‘shipment_ids’])) {
        fn_delete_shipments($_REQUEST[‘shipment_ids’]);
        if (!empty($_REQUEST[‘redirect_url’])) {
            return array(CONTROLLER_STATUS_REDIRECT, $_REQUEST[‘redirect_url]);
        }
    }
    return array(CONTROLLER_STATUS_OK, ‘orders’ . $suffix);
}
$params = $_REQUEST;
if ($mode == ‘details’) {
    if (empty($params[‘order_id’]) && empty($params[‘shipment_id’])) {
        return array(CONTROLLER_STATUS_NO_PAGE);
    }
    if (!empty($params[‘shipment_id’])) {
        $params[‘order_id.] = db_get_field(‘SELECT ?:shipment_items.order_id FROM
?:shipment_items WHERE ?:shipment_items.shipment_id = ?i’, $params[‘shipment_id’]);
    }
    $shippings = db_get_array(“SELECT a.shipping_id, a.min_weight, a.max_weight,
a.position, a.status, b.shipping, b.delivery_time, a.usergroup_ids FROM ?:shippings as
a LEFT JOIN ?:shipping_descriptions as b ON a.shipping_id = b.shipping_id AND
b.lang_code = ?s WHERE a.status = ?s ORDER BY a.position”, DESCR_SL, ‘A’);
    $order_info = fn_get_order_info($params[‘order_id’], false, true, true);
    if (empty($order_info)) {
        return array(CONTROLLER_STATUS_NO_PAGE);
    }
    if (!empty($params[‘shipment_id’])) {
        $params[‘advanced_info’] = true;
        list($shipment, $search) = fn_get_shipments_info($params);
        if (!empty($shipment)) {
            $shipment = array_pop($shipment);
            foreach ($order_info[‘products’] as $item_id => $item) {
                if (isset($shipment[‘products’][$item_id])) {
                  $order_info[‘products’][$item_id][‘amount’] =
$shipment[‘products’][$item_id];
                } else {
                  $order_info[‘products’][$item_id][‘amount’] = 0;
                }
            }
        } else {
            $shipment = array( );
        }
        Registry::get(‘view’)->assign(‘shipment’, $shipment);
    }
    Registry::get(‘view)->assign(‘shippings’, $shippings);
    Registry::get(‘view)->assign(‘order_info’, $order_info);
    Registry::get(‘view’)->assign(‘carriers’, fn_get_carriers( ));
} elseif ($mode == ‘manage’) {
    list($shipments, $search) = fn_get_shipments_info($params,
Registry::get(‘settings.Appearance.admin_elements_per_page’));
    Registry::get(‘view’)->assign(‘shipments’, $shipments);
    Registry::get(‘view’)->assign(‘search’, $search);
} elseif ($mode == ‘packing_slip’ && !empty($_REQUEST[‘shipment_ids’])) {
    fn_print_shipment_packing_slips($_REQUEST[‘shipment_ids’],
!empty($_REQUEST[‘format’]) && $_REQUEST[‘format’] == ‘pdf’);
    exit;
} elseif ($mode == ‘delete’ && !empty($_REQUEST[‘shipment_ids’]) &&
is_array($_REQUEST[‘shipment_ids’])) {
    $shipment_ids = implode(‘,’, $_REQUEST[‘shipment_ids’]);
    fn_delete_shipments($shipment_ids);
    return array(CONTROLLER_STATUS_OK, ‘shipments.manage’);
}
function fn_get_packing_info($shipment_id)
{
    $params[‘advanced_info’] = true;
    $params[‘shipment_id’] = $shipment_id;
    list($shipment, $search) = fn_get_shipments_info($params);
    if (!empty($shipment)) {
        $shipment = array_pop($shipment);
        $order_info = fn_get_order_info($shipment[‘order_id’], false, true, true);
        $shippings = db_get_array(“SELECT a.shipping_id, a.min_weight, a.max_weight,
a.position, a.status, b.shipping, b.delivery_time, a.usergroup_ids FROM ?:shippings as
a LEFT JOIN ?:shipping_descriptions as b ON a.shipping_id = b.shipping_id AND
b.lang_code = ?s ORDER BY a.position”, DESCR_SL);
        $_products = db_get_array(“SELECT item_id, SUM(amount) AS amount FROM
?:shipment_items WHERE order_id = ?i GROUP BY item_id”, $shipment[‘order_id’]);
        $shipped_products = array( );
        if (!empty($_products)) {
            foreach ($_products as $_product) {
                $shipped_products[$_product[‘item_id’]] = $_product[‘amount’];
            }
        }
        foreach ($order_info[‘products’] as $k => $oi) {
            if (isset($shipped_products[$k])) {
                $order_info[‘products’][$k][‘shipment_amount’] = $oi[‘amount’] −
$shipped_products[$k];
            } else {
                $order_info[‘products’][$k][‘shipment_amount’] =
$order_info[‘products’][$k][‘amount’];
            }
            if (isset($shipment[‘products’][$k])) {
                $order_info[‘products’][$k][‘amount’] = $shipment[‘products’][$k];
            } else {
                $order_info[‘products’][$k][‘amount’] = 0;
            }
        }
    } else {
        $shipment = $order_info = array( );
    }
    return array($shipment, $order_info);
}
function fn_print_shipment_packing_slips($shipment_ids, $pdf = false, $lang_code =
CART_LANGUAGE)
{
    $view =Registry::get(‘view’);
    foreach ($shipment_ids as $shipment_id) {
        list($shipment, $order_info) = fn_get_packing_info($shipment_id);
        if (empty($shipment)) {
            continue;
        }
        $view->assign(‘order_info’, $order_info);
        $view->assign(‘shipment’, $shipment);
        if ($pdf == true) {
            fn_disable_translation_mode( );
            $html[ ] = $view->displayMail(‘orders/print_packing_slip.tpl’, false, ‘A’,
$order_info[‘company_id’], $lang_code);
        } else {
            $view->displayMail(‘orders/print_packing_slip.tpl’, true, ‘A’,
$order_info[‘company_id’], $lang_code);
            if ($shipment_id != end($shipment_ids)) {
                echo(“<div style=‘page-break-before: always;’>&nbsp;</div>”);
            }
        }
    }
    if ($pdf == true) {
        Pdf::render($html, _(‘shipments’) . ‘-’ . implode(‘-’, $shipment_ids));
    }
    return true;
}
```

### Orders

```
<table class=“table table-middle”>
      <tr>
            <td>
                  <div class=“control-group”>
                        <label class=“control-label” for=“cr_start_date”>{“Start
date”}</label>
                        <div class=“controls”>
                        <p>{$cr_start_date}</p>
                        </div>
                  </div>
            </td><td>
                  <div class=“control-group”>
                        <label class=“control-label” for=“cr_end_date”>{“End
date”}</label>
                        <div class=“controls”>
                              <p>{$cr_end_date}</p>
                        </div>
                  </div>
            </td><td>
                  <div class=“control-group”>
                        <label class=“control-label”
for=“cr_duration”>{“Duration”}</label>
                        <div class=“controls”>
                              <p>{$cr_duration}</p>
                        </div>
                  </div>
            </td>
      </tr>
</table>
```

### Profiles

```
<h4>Call and response customers</h4>
<div class=“table-wrap”>
      <table class=“table” table-middle”>
            <thead>
            <tr>
                  <th width=“18%”>{“Email”}</th>
                  <th width=“10%” class=“center”>{“C&R Status”}</th>
                  <th width=“10%” class=“center”>{“C&R Status date”}</th>
                  <th width=“10%” class=“center”>{“Start date”}</th>
                  <th width=“10%” class=“center”>{“End date”}</th>
                  <th width=“8%” class=“center”>{“Start date set by the
administrator”}</th>
                  <th width=“10%” class=“center”>{“Status description”}</th>
                  <th width=“1%” class=“right”>{“Order ID”}</th>
                  <th width=“11%”>{“Time on change of order status”}</th>
                  <th width=“12%”>{“Date of order”}</th>
            </tr>
            </thead>
      </table>
      <div class=“scrollable-table”>
            <table class=“table table-striped”>
                  <tbody>
                        {foreach from=$call_and_response_stastus item=“row_data”}
                              <tr>
                                    <td>{$row_data.mail_from}</td>
                                    <td >{$row_data.current_status}</td>
                                    <td>{$row_data.current_status_timestamp}</td>
                                    <td>{$row_data.start_date}</td>
                                    <td>{$row_data.end_date}</td>
                                    <td>{$row_data.date_manually}</td>
                                    <td>{$row_data.description_date_manually}</td>
                                    <td>{$row_data.order_id}</td>
                                    <td
class=“center”>{$row_data.order_timestamp}</td>
                                    <td class=“center”>{$row_data.order_date}</td>
                              </tr>
                        {/foreach}
                  </tbody>
            </table>
      </div>
</div>
```

### Components

```
<script type=“text/javascript”>
//<![CDATA[
    var packages = [ ];
//]]>
</script>
                {hook name=“orders:authorization_date_man”}
                {* authorization_date_man info *}
                <tr class=“totals”>
                    <td width=“100px”><h4>Authorization date manually
entered</h4></td>
                </tr>
                {/hook}
<form action=“{“”|fn_url}” method=“post” name=“shipments_form” class=“form-horizontal
form-edit”>
<input type=“hidden” name=“shipment_data[order_id]” value=“{$order_info.order_id}” />
{foreach from=$order_info.shipping key=“shipping_id” item=“shipping”}
    {if $shipping.packages_info.packages}
        {assign var=“has_packages” value=true}
    {/if}
{/foreach}
<div class=“cm-tabs-content” id=“tabs_content”>
    <div id=“content_tab_general”>
        <table class=“table table-middle”>
        <thead>
            <tr>
                <th>{_(“product”)}</th>
                <th width=“5%”>{_(“quantity”)}</th>
            </tr>
        </thead>
        {assign var=“shipment_products” value=false}
        {foreach from=$order_info.products item=“product” key=“key”}
            {if $product.shipment_amount > 0 && (!isset($product.extra.group_key) ||
$product.extra.group_key == $group_key)}
            {assign var=“shipment_products” value=true}
            <tr>
                <td>
                    {assign var=may_display_product_update_link
value=“products.update”|fn_check_view_permissions}
                    {if $may_display_product_update_link &&
!$product.deleted_product}<a
href=“{“products.update?product_id=‘$product.product_id‘”|fn_url}”>{/if}{$product.product
|default:_(“deleted_product”) nofilter}{if
$may_display_product_update_link}</a>{/if}
                    {if
$product.product_code}<p>{_(“sku”)}:&nbsp;{$product.product_code}</p>{/if}
                    {if $product.product_options}<div class=“options-info”>{include
file=“common/options_info.tpl” product_options=$product.product_options}</div>{/if}
                </td>
                <td class=“center” nowrap=“nowrap”>
                        {math equation=“amount + 1” amount=$product.shipment_amount
assign=“loop_amount”}
                        {if $loop_amount <= 100}
                            <select id=“shipment_data_{$key}” class=“input-small cm-
shipments-product” name=“shipment_data[products][{$key}]”>
                                <option value=“0”>0</option>
                            {section name=amount start=1 loop=$loop_amount}
                                <option value=“{$smarty.section.amount.index}” {if
$smarty.section.amount.last}selected=“selected”{/if}>{$smarty.section.amount.index}</option>
                            {/section}
                            </select>
                        {else}
                            <input id=“shipment_data_{$key}” type=“text” class=“input-
text” size=“3” name=“shipment_data[products][{$key}]”
value=“{$product.shipment_amount}” />&nbsp;of&nbsp;{$product.shipment_amount}
                        {/if}
                </td>
            </tr>
            {/if}
        {/foreach}
        {if !$shipment_products}
            <tr>
                <td colspan=“2”>{_(“no_products_for_shipment”)}</td>
            </tr>
        {/if}
        </table>
        {include file=“common/subheader.tpl” title=“Start date for authorization for
C&R services”}
              {hook name=“orders:fpds_crauthorization_current_start_date”} {/hook}
        <fieldset>
            <div class=“control-group”>
                <label class=“control-label” for=“admin_payment_date”>{“New start
date”}</label>
                <div class=“controls”>
                                <p>{include file=“common/calendar.tpl”
date_id=“admin_payment_date_id” date_name=“admin_payment_date”
date_val=$admin_payment_date|default:$smarty.const.TIME
start_year=$settings.Company.company_start_year}</p>
                </div>
            </div>
            <div class=“control-group”>
                <label class=“control-label”
for=“shipment_comments”>{_(“comments”)}</label>
                <div class=“controls”>
                    <textarea id=“shipmentcomments” name=“shipment_data[comments]”
cols=“55” rows=“8” class=“span9”></textarea>
                </div>
            </div>
            <div class=“control-group”>
                <label class=“control-label”
for=“order_status”>{_(“order_status”)}</label>
                <div class=“controls”>
                    <select id=“order_status” name=“shipment_data[order_status]”>
                        <option value=“”>{_(“do_not_change”)}</option>
                        {foreach
from=$smarty.const.STATUSES_ORDER|fn_get_simple_statuses key=“key” item=“status”}
                            <option value=“{$key}”>{$status}</option>
                        {/foreach}
                    </select><p>{“N.B. This function is not activated”}</p>
                    <p class=“description”>
                        {_(“text_order_status_notification”)}
                    </p>
                </div>
            </div>
        </fieldset>
    </div>
</div>
<div class=“buttons-container”>
    {include file=“buttons/save_cancel.tpl”
but_name=“dispatch[fpds_crauthorization.add]” cancel_action=“close”}
</div>
</form>
```

### Use Case: Real-Time Streaming Data Aggregation

Case Study: Social Media Big Data.

This use case is an illustration of the Real-time Synchronous Processing Chain Architecture. In one embodiment, the present invention is implemented based on Pentaho toolset. Traditional data integration engines process data in a batch-oriented way. Pentaho Data Integration (Kettle) is typically deployed to run monthly, nightly, hourly workloads. In some cases, micro-batches of work can run every minute or so. However, in this embodiment we describe how Kettle transformation engine can be used to stream data indefinitely (never ending) from a source to a target. This data integration mode is referred to as being “real-time”, “streaming”, “near real-time”, “continuous” and so on. Typical examples of situations where there is a never-ending supply of data that needs to be processed the instance it becomes available are JMS (Java Message Service), RDBMS log sniffing, on-line fraud analyses, web or application log sniffing or Social Media data (e.g. Twitter, Facebook, etc). For illustrative purposes, we will Twitter service to demo the Pentaho Data Integration capabilities for processing streaming data in real-time.

Below are the high-level processing steps:
Step 1. Continuously read all the tweets that are being sent on Twitter
Step 2. Extract all the hash-tags used
Step 3. Count the number of hash-tags used in a one-minute time-window
Step 4. Report on all the tags that are being used more than once
Step 5. Put the output in a browser window, continuously update every minute.

The steps above a high level for illustrative purposes and are conceptually mapped to the processing steps described in FIG. 3 Real-Time (Synchronous) Processing Architecture. Step 1 refers to Data Asset Arrives and Internet or LAN. Step 2 refers to Traffic Processing Module. Step 3 refers to ETL Engine & Workflows. Step 4 refers to Data Integration Engine and Data Repository. Step 5 refers to Data Consumer Receives Asset.

Again, for illustrative purposes this is a very generic example but the logic of this can be applied to different fields like JMS, HL7, log sniffing and so on. Note that this processing job never ends and does time-based aggregation in contrast to aggregation over a finite data set.

In order for Kettle to fully support multiple streaming data sources support for “windowed” (time-based) joins and other capabilities is implemented.

Step 1. Continuously Read all the Tweets that are being Sent on Twitter.
For this we are going to use one of the public Twitter web services that deliver a never-ending stream of JSON messages:
http://stream.twitter.com/1/statuses/sample.json?delimited=length
Since the format of the output is never-ending and specific in nature a “User Defined Java Class” script is needed:

public boolean processRow(StepMetaInterface smi, StepDataInterface sdi)
throws KettleException
{
HttpClient client =
SlaveConnectionManager.getInstance( ).createHttpClient( );
client.setTimeout(10000);
client.setConnectionTimeout(10000);
Credentials creds = new
UsernamePasswordCredentials(getParameter(“USERNAME”),
getParameter(“PASSWORD”));
client.getState( ).setCredentials(AuthScope.ANY, creds);
client.getParams( ).setAuthenticationPreemptive(true);
HttpMethod method = new
PostMethod(“http://stream.twitter.com/1/statuses/sample.json?delimited=
length”);
// Execute request
//
InputStream inputStream=null;
BufferedInputStream bufferedInputStream=null;
try {
int result = client.executeMethod(method);
// the response
//
inputStream = method.getResponseBodyAsStream( );
bufferedInputStream = new BufferedInputStream(inputStream, 1000);
StringBuffer bodyBuffer = new StringBuffer( );
int opened=0;
int c;
while ( (c=bufferedInputStream.read( ))!=−1 && !isStopped( )) {
char ch = (char)c;
bodyBuffer.append(ch);
if (ch==‘{’) opened++; else if (ch==‘}’) opened−−;
if (ch==‘}’ && opened==0) {
// one JSON block, pass it on!
//
Object[ ] r = createOutputRow(new Object[0],
data.outputRowMeta.size( ));
String jsonString = bodyBuffer.toString( );
int startIndex = jsonString.indexOf(“{”);
if (startIndex<0) startIndex=0;
// System.out.print(“index=”+startIndex+“
json=”+jsonString.substring(startIndex));
r[0] = jsonString.substring(startIndex);
putRow(data.outputRowMeta, r);
bodyBuffer.setLength(0);
}
}
} catch(Exception e) {
throw new KettleException(“Unable to get tweets”, e);.
} finally {
bufferedInputStream.reset( );
bufferedInputStream.close( );
}
setOutputDone( );
return false;
}

As stated above, this step never ends as long as the Twitter service keeps on sending more data. As it is currently implemented, the transformation terminates with an error, sends an alert (e-mail, database, SNMP) and re-starts the transformation in a loop in a job. This way there is a trace in case Twitter feed is not operational for a few hours. The script above can be modified further to re-connect to the service every time it drops.

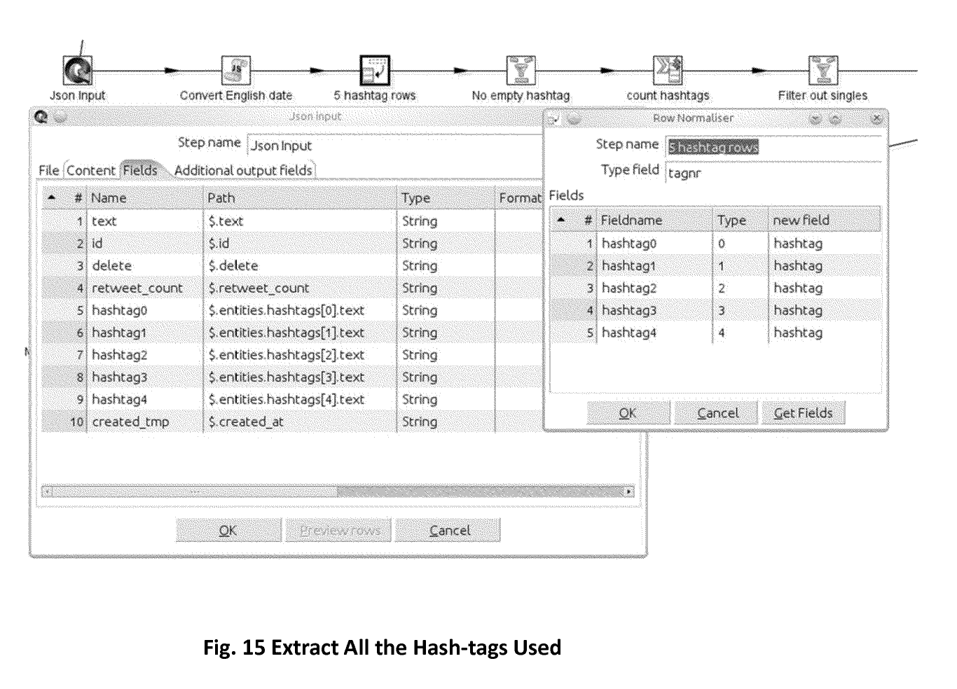

Step 2. Extract all the Hash-Tags Used
First we'll parse the JSON returned by the Twitter service, extract the first 5 hash-tags from the message, split this up into 5 rows and count the tags. FIG. 15 illustrates the concept.

Step 3. Count the Number of Hash-Tags Used in a One-Minute Time-Window
The counting uses a “Group by” step. However, to aggregate in a time-based fashion, the present invention has the “Single Threader” step, which has the option to aggregate in a time-based manner. FIG. 16 illustrates the concept.
This step accumulates all records in memory until 60 seconds have passed and then performs one iteration of the single threaded execution of the specified transformation. This is a special execution method that doesn't use the typical parallel engine. The records that go into the time-window can be grouped and sorted without the transformation being restarted every minute.

Step 4. Report on all the Tags that are being Used More than Once
The filtering is done with a simple “Filter Rows” step. However, leveraging the “Single Threader” step the present invention sorts the rows descending by the tag occurrence count in that one-minute time-window. It's also interesting to note that if you have huge amounts of data, the work can be parallelizes by starting multiple copies of the single threader step and/or with further data partitioning. For illustrative purposes, we can partition by hash-tag or re-aggregate the aggregated data.

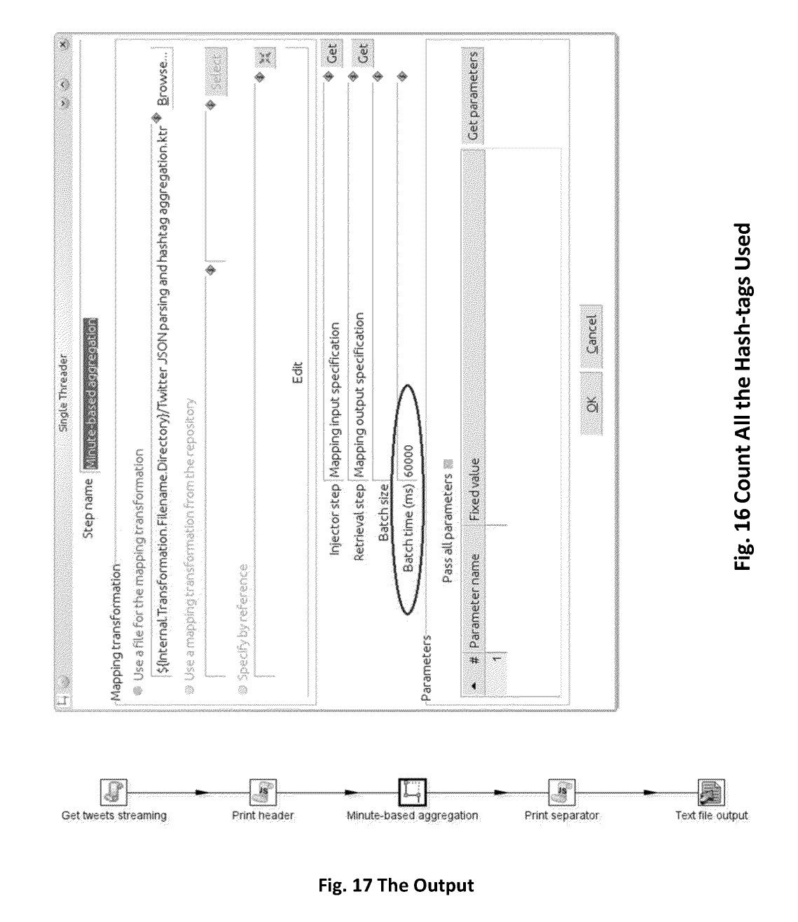

5. Put the Output in a Browser Window, Continuously Update Every Minute.
This step is done with a “Text File Output” step. However, a small header and a separator between the data from every minute is needed so that the transformation looks as illustrated in FIG. 17.
The script to print the header looks like this:

var out;
if (out==null) {
out = _step_.getTrans( ).getServletPrintWriter( );
out.println(“‘Real-time’ twitter hashtag report, minute based”);
out.flush( );
}

The separator between each minute is simple too:

```
if (nr==1) {
var out = _step_.getTrans( ).getServletPrintWriter( );
  out.println(“==========================================”);
out.println( );
  out.flush( );
}
```

This transformation can be executed on a Carte instance (4.2.0) and see the following output:

‘Real-time’ twitter hashtag report, minute based
=================================================
nr;hashtag;count;from;to
1;tatilmayonezi;5;2013/07/22 22:52:43.000;2013/07/22 22:53:32.000
2;AUGUST6THBUZZNIGHTCLUB;3;2013/07/22 22:52:43.000;2013/
07/22 22:53:32.000
3;teamfollowback;3;2013/07/22 22:52:43.000;2013/07/22 22:53:32.000
4;ayamzaman;2;2013/07/22 22:52:43.000;2013/07/22 22:53:32.000
5;dnd;2;2013/07/22 22:52:43.000;2013/07/22 22:53:32.000
6;follow;2;2013/07/22 22:52:43.000;2013/07/22 22:53:32.000
7;malhacao;2;2013/07/22 22:52:43.000;2013/07/22 22:53:32.000
8;rappernames;2;2013/07/22 22:52:43.000;2013/07/22 22:53:32.000
9;thingswelearnedontwitter;2;2013/07/22 22:52:43.000;2013/07/22
22:53:32.000
=================================================
1;ska;5;2013/07/22 22:53:35.000;2013/07/22 22:54:47.000
2;followplanetjedward;4;2013/07/22 22:53:35.000;2013/07/22
22:54:47.000
3;chistede3pesos;3;2013/07/22 22:53:35.000;2013/07/22 22:54:47.000
4;NP;3;2013/07/22 22:53:35.000;2013/07/22 22:54:47.000
5;rappernames;3;2013/07/22 22:53:35.000;2013/07/22 22:54:47.000
6;tatilmayonezi;3;2013/07/22 22:53:35.000;2013/07/22 22:54:47.000
7;teamfollowback;3;2013/07/22 22:53:35.000;2013/07/22 22:54:47.000
8;AvrilBeatsVolcano;2;2013/07/22 22:53:35.000;2013/07/22 22:54:47.000
9;CM6;2;2013/07/22 22:53:35.000;2013/07/22 22:54:47.000
10;followme;2;2013/07/22 22:53:35.000;2013/07/22 22:54:47.000
11;Leao;2;2013/07/22 22:53:35.000;2013/07/22 22:54:47.000
12;NewArtists;2;2013/07/22 22:53:35.000;2013/07/22 22:54:47.000
13;OOMF;2;2013/07/22 22:53:35.000;2013/07/22 22:54:47.000
14;RETWEET;2;2013/07/22 22:53:35.000;2013/07/22 22:54:47.000
15;sougofollow;2;2013/07/22 22:53:35.000;2013/07/22 22:54:47.000
16;swag;2;2013/07/22 22:53:35.000;2013/07/22 22:54:47.000
17;thingswelearnedontwitter;2;2013/07/22 22:53:35.000;2013/07/22
22:54:47.000

### Use Case: Data Fusion

Case Study: Intelligence Community.

This use case is an illustration of the Real-time Synchronous Processing Chain Architecture of the present invention. Create a matrix of known threats and monitor data and surveillance video feeds for pattern recognition match. Intelligence analysis faces a difficult task of analyzing volumes of information from variety of sources. Complex arguments are often necessary to establish credentials of evidence in terms of its relevance, credibility, and inferential weight.

Establishing these three evidence credentials involves finding defensible and persuasive arguments to take into account. Data fusion capability of the present invention helps an intelligence analyst cope with the many complexities of intelligence analysis. A Data Asset can be a smartphone, tablet or a wearable computer (like Google Glass). The data asset device scans for face pattern recognition using reference data defined in the Data Fusion and Exchange Hub.

Once a probable pattern match is identified, it forwards the information to the Data Fusion and Exchange Hub that in turn does face recognition matching processed data against centralized data repository. In addition to the data asset device, both active (video streams) and passive (video surveillance) data feeds are used to substantiate the pattern match. In one embodiment, at the Data Fusion and Exchange Hub, an ontology model performs symbolic probabilities for likelihood, based on standard estimative language, and a scoring system that utilize Bayesian intervals.

| Interval Name | Interval |
|---|---|
| almost certain | [0.8, 1.0] |
| Likely | [0.6, 0.8] |
| even chance | [0.4, 0.6] |
| Unlikely | [0.2, 0.4] |
| remote possibility | [0.0, 0.2] |
| no evidence | [0.0, 0.0] |

### Use Case: Logic Fusion

Case Study: Business TRIZ Problem Solver.

This use case is an illustration of the “Call and Response” Asynchronous Processing Chain Architecture of the present invention. Create a pattern driven master hub allowing for constraint business problem resolution informed by internal and external to the organization data. One of the core principals of business TRIZ (Theory of Inventive Problem Solving): instead of directly jumping to solutions, TRIZ offers to analyze a problem, build its model, and apply a relevant pattern of a solution form the TRIZ pattern driven master hub to identify possible solution directions:

Problem Analysis>Specific Problem>Abstract Problem>Abstract Solution>Specific Solutions.

A business has a specific problem to address (the “call”); problem is then matched by the present invention to business taxonomies that abstract the problem; abstract problem is then fed to the pattern driven master hub (Logic Fusion) that provides an abstract solution; Abstract solution is then mapped to Definitional Taxonomies that provide a specific solution. The results are presented to the user of the present invention (the “response”).

Problems in TRIZ terms are represented by a contradiction—“positive effect vs. negative effect”, where both effects appear as a result of a certain condition. Once a contradiction is identified, the next step is to solve it. The ideal solution is to address the contradiction by neither compromising nor optimizing it, but rather eliminate the contradiction in a “win-win” way.

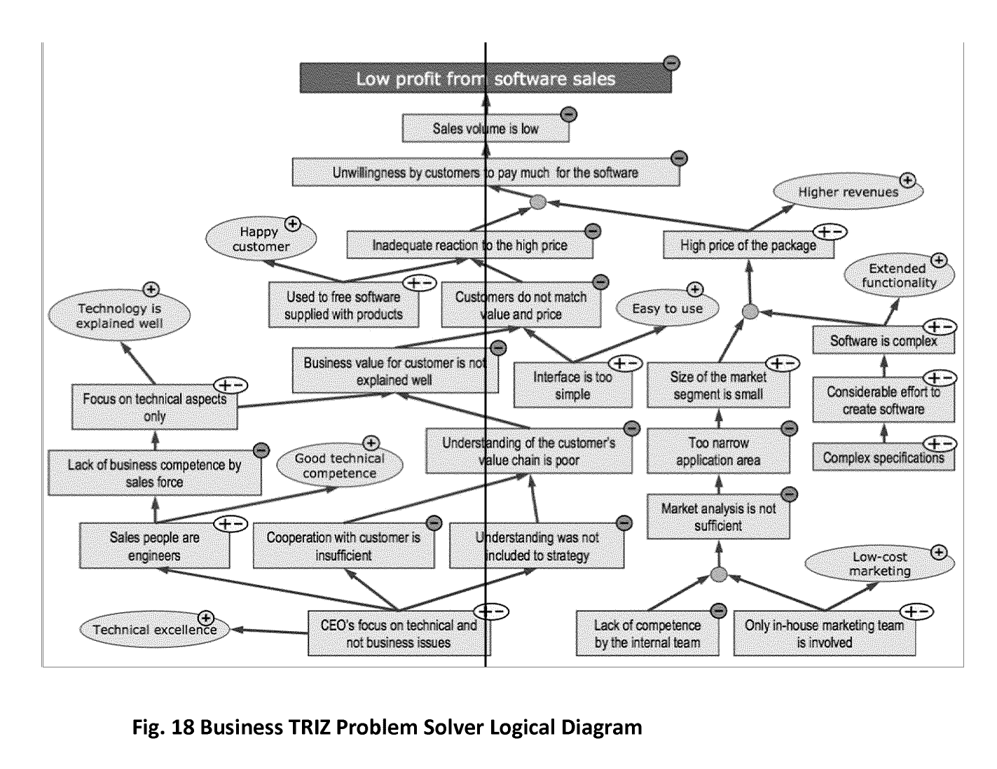

Logic Fusion represents the contradiction matrix, which provides a systematic access to most relevant subset of inventive principals depending on the type of a contradiction. FIG. 18 illustrates finding an ideal solution to address a contradiction.

Use Case: Business Management (Variation of the Business TRIZ Problem Solver).

This use case is an illustration of the Public-Private CONOPS of the present invention. Manage analysis and decisions of business patterns defined in a public data fusion and exchange hub containing domain specific solutions, informed by external to the organization public data.

Private instances of the public hub are then created for each specific Organizational purposes, allowing private to the Organization data to be integrated into the hub. For illustrative purposes, the Business issue is Risk Compliance. Domain 1 is Healthcare, domain 2 is Aviation Safety, domain 3 is manufacturing, . . . , domain 8 is financial services/lending, etc. Taking domain 8 as an example, the Public Hub will contain all requirements, TRIZ principles and domain solutions. The Private Instance of domain 8 for Bank of America (BofA) will contain BofA specifics. The Private Instance of domain 8 Wells Fargo will contain Wells Fargo specifics. In one embodiment, new compliance solution defined in the Wells Fargo Private Hub Instance, will be made available in analogous TRIZ terms to the Private Hub Instance of domain 8 for BoA.

In one embodiment, the Public-private CONOPS can be implemented as an appliance-based architecture. In this example, the Public hub resides in a Management Console and is integrated with all external data assets (integrate data once, reuse multiple times). Each Private instance resides in an Appliance where additional private to the organization data is integrated and protected from the Public Hub or other Private Instances. All Data Consumers are connected to the Private instance of the Hub residing on the Appliance. Based on configuration rules, data from the Private Hub Instances can be integrated into the Public Hub or not. In one embodiment, the ontological patterns detected/defined in the Private Instance are sent and integrated into the Management Console. This enhances the analysis and decision ability for at the Public Hub and all Private Instances.

### Use Case: Knowledge Fusion

Case Study: Self-Learning Knowledge Repository.

This use case is an illustration of a hybrid Synchronous and Asynchronous Processing Chain Architectures of the present invention. The objective of this use case is to set up a system to (1) improve information/knowledge retrieval and (2) improve information knowledge integration.

The Data Fusion and Exchange Hub has the goal to create self-learning ontology capturing what an individual actor (e.g. employee of an organization) knows and what the community (e.g. the corporation for which the employee is associated with) knowledge base is. In this embodiment, the integration of data from the data assets is based on the Real-time Synchronous Architecture of the present invention, while the Knowledge Queries from the user (Data Consumer) are based on the “Call and Response” Asynchronous Processing Architecture of the present invention.
Improve information/knowledge retrieval. Knowledge fusion solution helps an individual actor (data consumer) to retrieve efficiently and precisely exactly the information needed, when needed, and in the format needed. The retrieval of the needed information and only the needed information is a complex challenge and requires deep understanding of the domain, the context, the content, the purpose, and the role/intent of the actor. For example, traditional search against an enterprise data repository (e.g. Knowledge Management System, Content Management System, or Learning Management System) often presents the challenge for the user to retrieve exactly what needed, especially when not clear to the user what they are looking for.
Improve information knowledge integration. Knowledge fusion helps all available information to be integrated into the ontological data repository for retrieval. This can happen passively (i.e. the actor submits information to the system) or actively (i.e. the system “scans” for available and relevant information and automatically integrates it).

In one embodiment, data asset device can be a smartphone, tablet or a wearable computer (like Google Glass). The data asset device scans the environment (e.g. a computer system, traffic of data, data repositories, or the real world) for relevant information using reference data pushed by the appliance. Once a probable pattern match is identified, it forwards the information to the Data Fusion and Exchange Hub that in turn integrates the data into the ontological data repository. Some of the integrated data can be sensitive and needs to be “cleansed” before been integrated into the ontological data repository stored on the Hub. In some embodiments, in addition, the data feed from a data asset may also require post processing before been integrated into the Data Fusion and Exchange Hub.

When a new concept or pattern is detected at the Data Fusion and Exchange Hub, it is instantly available to all Data Consumers for (1) ability for user to retrieve data based on the new pattern, and (2) ability for the system to detect relevant data and integrate it as available knowledge for future retrieval.

In one embodiment, the Knowledge Fusion system has five (5) user (Data Consumer) sub use cases:
I know what I don't know and I know where it is. I can query the system for information. My challenge is information overload. The system helps refine the results of the query and only present the relevant information.
I know what I know. I can contribute my knowledge. The system integrates the information in a semi-automated fashion thus reducing the time it takes to build new knowledge base.
I don't know that such information exist, but I can benefit from it. The system finds it for me. Because of my “ignorance” my query doesn't have an answer, but the system determines what the “real” query should have been and returns the answer to that query.
I don't know what I know. I create content that can be used by others. The system automatically finds it and integrates it.
Activity and Anomaly Detection. The system automatically builds the knowledge base using my login information and the content of my queries.
   Use Case: e-Discovery

Case Study: Legal e-Discovery Collection and Preservation.

This use case is an illustration of Synchronous Processing Chain Architectures of the present invention. The objective of this use case is to assert direct control over legal data management activities such as preservation and collection, while reducing the impact on information technology. Legal teams gain 360-degrees visibility into the entire e-discovery process from identification through production, while (1) eliminating the chaos of manual processes, (2) cutting the risk of evidence spoliation and sanctions, (3) improve efficiency, transparency, defensibility and repeatability.

Available as both Software as a Service (SaaS) and Appliance mode, the Data Fusion and Exchange Hub drives early case assessment, and preserves, collects, culls and analyzes potentially relevant information in an automated, easy-to-deploy and administer package.
Improve legal information retrieval. Data Fusion and Exchange Hub can quickly scan information technology (IT) infrastructure, including potential custodial and non-custodial data sources. Once information is retrieved, it is classified using a pre-defined ontology model based on the type of e-Discovery like: patent litigations, mergers and acquisitions, securities and financial services, criminal defense, etc. Once classified, discovery teams can efficiently sift through evidence and arrive at an informed case strategy at the outset of a matter, all from a coherent set of data. The interplay of custodian scoping and early evidence review delivers timely insights that legal teams have, until now struggled to obtain.

What is claimed is:

1. A computer-based method to facilitate and orchestrate the exchange and integration of data, the method comprising the steps of:
i. Automated framework comprised of technical devices for enabling integration of one or more of data assets and data consumers;
ii. Manage or synchronize data;
iii. Memory for storing data about data assets and data consumers;
iv. An interface for receiving communications from plurality of data assets and plurality of end-devices;
v. Translate the incoming communication from the data assets to the recognizable data format corresponding to the end-device(s).
vi. One or more computers with server functions for holding and presenting the described information.

2. The method of claim 1, where the said integration can be one of asynchronous messaging-based, asynchronous near real-time, synchronous real-time.

3. The method of claim 1 where the said assets are one or more of data streamer, structured data repository, unstructured data repository, 3rd party application, ontology, sensor, service provider, text, image, video, voice;

4. The method of claim 1 where the said consumers are one or more of human user, web portal, email, repository of data, reporting warehouse, 3rd party application, workflow, analytics process, model, ontology index, problem solver, decision system, mobile device, sensor, wearable computer;

5. The method of claim 1, wherein the said frame work is further comprised of steps one or more of the following processing layers: hardware, operating system, database, channels, logic, application, presentation;

6. The method of claim 1, wherein the said interface is further comprising of steps for receiving communications from data assets and sending communications to data consumers using a common protocol, encrypted or not;

7. The method of claim 1, wherein the said technical devices comprise at least one of authentication, rights and roles, data assets, or data consumers.

8. The method of claim 1, wherein the said memory is further comprising storing applications for distribution to the data consumers.

9. The method of claim 1, wherein the said framework is comprised of steps for signaling to an operator;

10. The method of claim 1, wherein the said framework further comprises of steps of an eCommerce application for enabling payment or credit disposition during the said exchange and integration of data;

11. A computer appliance-based method to facilitate and orchestrate the exchange and integration of data, the method comprising the steps of:
i. Automated framework comprised of technical devices for enabling integration of one or more of data assets and data consumers;
ii. Providing a plurality of computer appliances comprising of processing steps for establishing an automated framework comprised of technical devices for enabling integration of one or more of data assets and data consumers
iii. Logic rules, data repositories and/or services together to automate, manage, synchronize or monitor data exchange;
iv. Memory for storing data about data assets and data consumers;
v. An interface for receiving communications from plurality of data assets and plurality of end-devices;
vi. Translate the incoming communication from the data assets to the recognizable data format corresponding to the end-device(s).
vii. One or more computers with server functions for holding and presenting the described information.

12. The method of claim 11, where the said integration can be one of asynchronous messaging-based, asynchronous near real-time, synchronous real-time.

13. The method of claim 11 where the said assets are one or more of data streamer, structured data repository, unstructured data repository, 3rd party application, ontology, sensor, service provider, text, image, video, voice;

14. The method of claim 11 where the said consumers are one or more of human user, web portal, email, repository of data, reporting warehouse, 3rd party application, workflow, analytics process, model, ontology index, problem solver, decision system, mobile device, sensor, wearable computer;

15. The method of claim 11, wherein the said appliances include a control center is comprised of steps for registering the other said computer appliances for the purposes of one or more of management, control, remote administration, re-registering, re-provisioning, updating software, ensuring updates/security fixes/configuration files are applied, monitors operation and performance;

16. The method of claim 11, wherein the said appliances are comprised of the processing steps and logic and procedures for enabling the said interface for receiving communications from data assets and sending it to data consumers, encrypted or not;

17. The method of claim 11, wherein the said technical devices comprise at least one of authentication, rights and roles, data assets, or data consumers.

18. The method of claim 11, wherein the said memory is further comprising storing applications for distribution to the data consumers.

19. The method of claim 11, wherein the said framework is comprised of steps for signaling to an operator;

20. The method of claim 11, wherein the said framework further comprises of steps of an eCommerce application for enabling payment or credit disposition during the said exchange and integration of data.
